(19) United States
(12) Patent Application Publication
(10) Pub. No.: US 2026/0259098 A1
(43) Pub. Date: Sep. 3, 2026

(54) CENTER OF GRAVITY DETERMINATION BY FORCE MEASUREMENTS

(71) Applicant: Intel Corporation, Santa Clara, CA (US)

(72) Inventors: Mark VAYNBERG, Petah Tikva (IL); Mika HAUTAMAKI, Vesilahti (FI); Gregory HEIFETS, Rehovot (IL); Timo HERRANEN, Akaa (FI); Dan HOROVITZ, Rishon LeTsiyon (IL)

(21) Appl. No.: 19/066,203

(22) Filed: Feb. 28, 2025

(51) Int. Cl. G01M 1/12

(52) U.S. Cl. CPC G01M 1/122

(57) ABSTRACT

A device of a vehicle; the device may include: an interface configured to receive sensor data representing force measurements from two force sensors; and a processor configured to: instruct a carrier structure controller to adjust an orientation of a carrier structure; and determine a vertical center of gravity location for a load applying force to the two sensors based on stored sensor positions of the two sensors and the sensor data representing the force measurements.

### TECHNICAL FIELD

This disclosure generally relates to methods and devices for vehicles, specifically for autonomous or automated vehicles.

### BACKGROUND

The stability and performance of vehicles during motion are critically influenced by their center of gravity, a parameter that directly impacts their handling, braking, and safety. In any moving vehicle, the distribution and height of the center of gravity determine its dynamic stability, particularly during acceleration, deceleration, and directional changes. Improper positioning of the center of gravity, especially a high or off-centered load, can lead to tipping hazards, reduced maneuverability, or increased stopping distances.

The need to maintain precise control over the center of gravity becomes even more pronounced in vehicles designed for automated or semi-automated operations, where human intervention is minimized, and operational safety depends entirely on system-driven monitoring and responses. These challenges underline the importance of accurately measuring not only the planar (horizontal) center of gravity but also its vertical component, a task critical for enhancing the safety and performance of a broad range of vehicle types, including automated mobile robots (AMRs) and automated guided vehicles (AGVs).

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary vehicle and a mobility system.

FIG. 2 shows an exemplary control system of the vehicle.

FIG. 3 illustrates an illustration of a vehicle in accordance with various aspects described herein.

FIG. 4 shows an illustrative example of a device.

FIG. 5 shows an exemplary illustration of a carrier structure to carry the load.

FIG. 6 shows an example of a flow diagram in accordance with aspects described herein.

FIG. 7 shows an schematic illustration of a vehicle.

FIG. 8 shows an illustrative example of a top view of a vehicle.

FIG. 9 shows an illustrative example of a top view of a vehicle.

FIG. 10 shows an example of a method.

### DESCRIPTION

The following detailed description refers to the accompanying drawings that show, by way of illustration, exemplary details and aspects in which aspects of the present disclosure may be practiced.

Aspects described herein may relate to determination of a three-dimensional center of gravity (COG) of loads in vehicles, such as automated mobile robots (AMRs) and automated guided vehicles (AGVs).

Vehicles, such as AMRs and AGVs may be employed in various types of operations, including logistics, manufacturing, and material handling environments. Their ability to transport various loads, sometimes with minimal human intervention, may have led to significant enhancements in operational efficiency. However, the stability and safety of such systems may still have critical concerns, especially when handling loads with varying or unknown weight distributions. An important factor affecting the stability of these systems may be the COG of the load. If the COG shifts beyond acceptable thresholds, it can lead to hazards such as tipping, impaired braking performance, or compromised maneuverability.

Existing systems typically employ force sensors, such as load cells, strategically positioned beneath the platform or the load itself to measure the weight distribution and calculate the two-dimensional (X and Y axes) COG. These solutions, while effective for planar stability, fail to consider the height (Z-axis) of the COG. This limitation may leave a significant gap in addressing stability concerns in scenarios where vertical load dynamics play a critical role. The COG may refer to the point where the COG is located, which may also be referred to as center of mass, barycenter, balance point. As described herein the COG location may also be used to refer to the point where the COG is located.

The reliance is towards on detecting the two-dimensional COG in traditional systems to determine if the load is within safe handling limits. This may generally involve the use of four force sensors, such as load cells, positioned at known locations under the load-bearing platform. These force sensors may measure the forces exerted by the load and enable computation of the COG in the horizontal plane (i.e. horizontal COG location). Such systems, however, do not account for the vertical position of the COG (i.e. vertical COG location). As a result, they cannot assess the full stability profile of the vehicle, particularly in conditions where the load's height significantly alters its dynamic behavior.

The inability to measure the height of the COG (i.e. vertical COG location) may introduce substantial risks. For example, a load with a high vertical COG may create tipping moments during acceleration, deceleration, or turning. Additionally, it may adversely affect the vehicle's emergency braking distance and overall handling characteristics. These factors may necessitate more frequent manual interventions, reducing the efficiency of the automated system and increasing operational costs.

Force sensors, such as load cells, are widely used in diverse applications to measure weight and force distributions. These sensors can operate by converting physical forces, including tension, compression, pressure, or torque, into standardized electrical signals for computational analysis. When strategically positioned, force sensors can determine weight distribution to compute the two-dimensional COG. This method may be applied in automotive, aerospace, and robotics industries to enhance stability and ensure reliable operation of vehicles and machines. Despite their widespread application, current systems do not provide mechanisms to detect or measure the height of the COG. While the horizontal distribution of weight is effectively managed through these solutions, the vertical dynamics may remain unaddressed. This gap may be particularly significant for moving systems, such as AMRs and AGVs, where load stability during motion is important.

Loads with higher centers of gravity are inherently more unstable, particularly during dynamic movements such as acceleration or turning. The reliance on two-dimensional COG calculations does not account for the torque generated due to the height of the COG, which may lead to potentially dangerous scenarios. For instance, a sudden stop or turn might cause a high COG load to tip over, jeopardizing the safety of the vehicle, the load, and the surrounding environment. Furthermore, the inability to dynamically measure and respond to COG height may preclude the implementation of advanced safety protocols. For example, without vertical COG data, the system cannot adjust its acceleration, speed, or turning radius based on the load's stability. This limitation may result in conservative operating parameters, reducing the overall efficiency and throughput of the automated system.

Aspects described herein may aim to overcome the limitations of existing systems by introducing an apparatus and method capable of dynamically measuring the three-dimensional COG, including illustratively the height (i.e. vertical COG location), of a load on a moving vehicle. This capability may allow for real-time stability assessments during controlled acceleration phases. By employing multiple force sensors and leveraging principles of mechanics, the system may calculate the vertical position of the COG based on the forces exerted on the sensors during motion.

Aspects described herein may particularly be suited for integration into autonomous vehicles, such as AMRs and AGVs, but may equally be applicable to other moving vehicles requiring advanced stability control. Following the detection of the vertical COG, the aspects described herein may include evaluation of whether the calculated height exceeds predefined safety thresholds. Depending on the result, the vehicle may continue operation, reduce speed, or halt entirely to prevent hazardous conditions. Through performing some aspects described herein, a device may enhance operational safety, minimize risks associated with load tipping, and optimize vehicle performance by enabling adaptive speed and movement control based on load dynamics.

A “vehicle” may be understood to include any type of driven or drivable object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

A “ground vehicle” may be understood to include any type of vehicle, as described above, which is configured to traverse or be driven on the ground, e.g., on a street, on a road, on a track, on one or more rails, off-road, etc. An “aerial vehicle” may be understood to be any type of vehicle, as described above, which is capable of being maneuvered above the ground for any duration of time, e.g., a drone. Accordingly, similar to a ground vehicle having wheels, belts, etc., for providing mobility on terrain, an “aerial vehicle” may have one or more propellers, wings, fans, among others, for providing the ability to maneuver in the air. An “aquatic vehicle” may be understood to be any type of vehicle, as described above, which is capable of being maneuvered on or below the surface of liquid, e.g., a boat on the surface of water or a submarine below the surface. It is appreciated that some vehicles may be configured to operate as one of more of a ground, an aerial, and/or an aquatic vehicle.

The term “autonomous vehicle” may describe a vehicle capable of implementing at least one navigational change without driver input. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

Various aspects described herein may utilize one or more machine learning models to perform or control functions of the vehicle (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as force measurement data, image data, radar data, LIDAR data, and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

Throughout the present disclosure, the following terms may be used as synonyms: driving parameter set, driving model parameter set, safety layer parameter set, driver assistance, automated driving model parameter set, and/or the like (e.g., driving safety parameter set). These terms may correspond to groups of values used to implement one or more models for directing a vehicle in the manners described in this disclosure.

Furthermore, throughout the present disclosure, the following terms may be used as synonyms: driving parameter, driving model parameter, safety layer parameter, driver assistance and/or automated driving model parameter, and/or the like (e.g., driving safety parameter), and may correspond to specific values within the previously described sets.

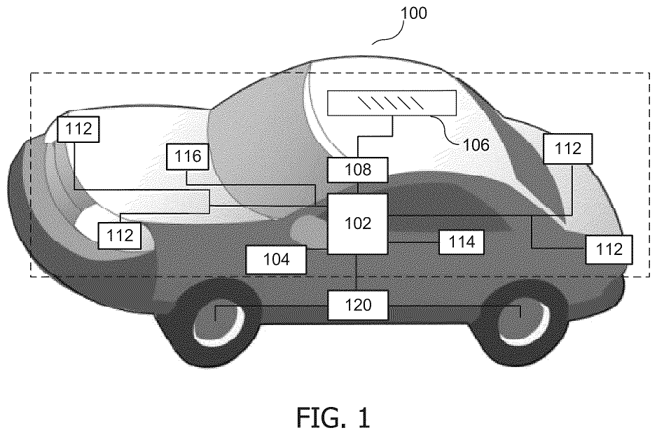

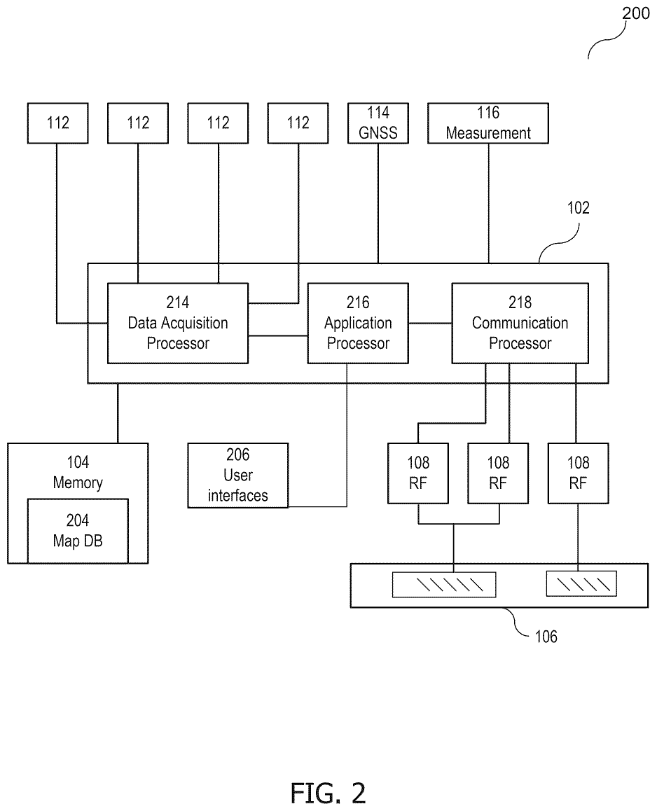

FIG. 1 shows a vehicle 100 including a mobility system 120 and a control system 200 (see also FIG. 2). FIG. 1 and FIG. 2 are provided in a complementary manner. It is appreciated that vehicle 100 and control system 200 are exemplary in nature and may thus be simplified for explanatory purposes. For example, while vehicle 100 is depicted as a ground vehicle, this may be equally or analogously applied to aerial vehicles, water vehicles (e.g. sea vehicles, underwater vehicles), and such. Furthermore, the quantities and locations of elements, as well as relational distances (as discussed above, the figures are not to scale) are provided as examples and are not limited thereto. The components of vehicle 100 may be arranged around a vehicular housing of vehicle 100, mounted on or outside of the vehicular housing, enclosed within the vehicular housing, or any other arrangement relative to the vehicular housing where the components move with vehicle 100 as it travels.

In addition to including a control system 200, vehicle 100 may also include a mobility system 120. Mobility system 120 may include components of vehicle 100 related to steering and movement of vehicle 100. In some aspects, where vehicle 100 is an automobile, for example, mobility system 120 may include wheels and axles, a suspension, an engine, a transmission, brakes, a steering wheel, associated electrical circuitry and wiring, and any other components used in the driving of an automobile. In some aspects, where vehicle 100 is an aerial vehicle, mobility system 120 may include one or more of rotors, propellers, jet engines, wings, rudders or wing flaps, air brakes, a yoke or cyclic, associated electrical circuitry and wiring, and any other components used in the flying of an aerial vehicle. In some aspects, where vehicle 100 is an aquatic or sub-aquatic vehicle, mobility system 120 may include any one or more of rudders, engines, propellers, a steering wheel, associated electrical circuitry and wiring, and any other components used in the steering or movement of an aquatic vehicle.

In some aspects, mobility system 120 may also include autonomous driving functionality, and accordingly may include an interface with one or more processors 102 configured to perform autonomous driving computations and decisions and an array of sensors for movement and obstacle sensing. In this sense, the mobility system 120 may be provided with instructions to direct the navigation and/or mobility of vehicle 100 from one or more components of the control system 200. The autonomous driving components of mobility system 120 may also interface with one or more radio frequency (RF) transceivers 108 to facilitate mobility coordination with other nearby vehicular communication devices and/or central networking components. The devices or components can perform decisions and/or computations related to autonomous driving. The autonomous driving components of mobility system 120 may also interface with one or more radio frequency (RF) transceivers 108 to facilitate mobility coordination with other nearby vehicular communication devices and/or central networking components, such as a traffic infrastructure system, or a roadside unit, or a monitoring system.

The control system 200 may include various components depending on the requirements of a particular implementation. As shown in FIG. 1 and FIG. 2, the control system 200 may include one or more processors 102, one or more memories 104, an antenna system 106 which may include one or more antenna arrays at different locations on the vehicle for radio frequency (RF) coverage, one or more radio frequency (RF) transceivers 108, one or more data acquisition devices 112, one or more position devices 114 which may include components and circuitry for receiving and determining a position based on a Global Navigation Satellite System (GNSS) and/or a Global Positioning System (GPS), and one or more measurement sensors 116, e.g. force sensor, load cell, speedometer, altimeter, gyroscope, velocity sensors, etc.

In accordance with various aspects described herein, the control system 200 may be configured to control the vehicle's 100 mobility via mobility system 120 and/or interactions with its environment, e.g. communications with other devices or network infrastructure elements (NIEs) such as base stations, via data acquisition devices 112 and the radio frequency communication arrangement including the one or more RF transceivers 108 and antenna system 106.

It is to be noted that the control system 200 may include any (control or other) function in the vehicle 100 (e.g. a passenger car, a truck, a motorcycle, an electric bicycle, an electric trolley, etc.) which may affect the behavior of the vehicle (such as a function controlling the vehicle speed, the vehicle position with respect to other vehicle (for example distance control to a vehicle in front), etc.) and/or which may control any external communication of the vehicle for example through C-V2X, ITS-G5, DSRC or any other suitable communication protocol, some of which are described herein and/or which may relate to any automation/autonomy enabling function of a vehicle (including the SAE levels defined as follows:
Level 0 (No Driving Automation)
Level 1 (Driver Assistance)
Level 2 (Partial Driving Automation)
Level 3 (Conditional Driving Automation)
Level 4 (High Driving Automation)
Level 5 (Full Driving Automation))”

The one or more processors 102 may include a data acquisition processor 214, an application processor 216, a communication processor 218, and/or any other suitable processing device. Each processor 214, 216, 218 of the one or more processors 102 may include various types of hardware-based processing devices. By way of example, each processor 214, 216, 218 may include a microprocessor, pre-processors (such as an image pre-processor), graphics processors, a CPU, support circuits, digital signal processors, integrated circuits, memory, or any other types of devices suitable for running applications and for image processing and analysis. Each processor 214, 216, 218 may include any type of single or multi-core processor, mobile device microcontroller, central processing unit, etc. These processor types may each include multiple processing units with local memory and instruction sets. Such processors may include video inputs for receiving image data from multiple image sensors and may also include video out capabilities.

Any of the processors 214, 216, 218 disclosed herein may be configured to perform certain functions in accordance with program instructions which may be stored in a memory of the one or more memories 104. In other words, a memory of the one or more memories 104 may store software that, when executed by a processor (e.g., by the one or more processors 102), controls the operation of the system, e.g., a driving and/or safety system. A memory of the one or more memories 104 may store one or more databases and image processing software, as well as a trained system, such as a neural network, or a deep neural network, for example. The one or more memories 104 may include any number of random-access memories, read only memories, flash memories, disk drives, optical storage, tape storage, removable storage and other types of storage. Alternatively, each of processors 214, 216, 218 may include an internal memory for such storage.

The data acquisition processor 214 may include processing circuitry, such as a CPU, for processing data acquired by data acquisition units 112. For example, if one or more data acquisition units are image acquisition units including sensors e.g. one or more cameras, then the data acquisition processor may include image processors for processing image data using the information obtained from the image acquisition units as an input. The data acquisition processor 214 may therefore be configured to create voxel maps detailing the surrounding of the vehicle 100 based on the data input from the data acquisition units 112, i.e., cameras in this example. For example, the one or more data acquisition units may include sensors, and the data acquisition processor 214 may receive information from the sensors and provide sensor data to the application processor. The sensor data may include information indicating the detections performed by the sensors.

Application processor 216 may be a CPU, and may be configured to handle the layers above the protocol stack, including the transport and application layers. Application processor 216 may be configured to execute various applications and/or programs of vehicle 100 at an application layer of vehicle 100, such as an operating system (OS), a user interfaces (UI) 206 for supporting user interaction with vehicle 100, and/or various user applications. Application processor 216 may interface with communication processor 218 and act as a source (in the transmit path) and a sink (in the receive path) for user data, such as voice data, audio/video/image data, messaging data, application data, basic Internet/web access data, etc. Application processor 216 may interface with the data acquisition processor 214 to receive sensor data.

In the transmit path, communication processor 218 may therefore receive and process outgoing data provided by application processor 216 according to the layer-specific functions of the protocol stack, and provide the resulting data to digital signal processor 208. Communication processor 218 may then perform physical layer processing on the received data to produce digital baseband samples, which digital signal processor may provide to RF transceiver 108. RF transceiver 108 may then process the digital baseband samples to convert the digital baseband samples to analog RF signals, which RF transceiver 108 may wirelessly transmit via antenna system 106.

In the receive path, RF transceiver 108 may receive analog RF signals from antenna system 106 and process the analog RF signals to obtain digital baseband samples. RF transceiver 108 may provide the digital baseband samples to communication processor 218, which may perform physical layer processing on the digital baseband samples. Communication processor 218 may then provide the resulting data to other processors of the one or more processors 102, which may process the resulting data according to the layer-specific functions of the protocol stack and provide the resulting incoming data to application processor 216. Application processor 216 may then handle the incoming data at the application layer, which can include execution of one or more application programs with the data and/or presentation of the data to a user via a user interface 206. User interfaces 206 may include one or more screens, microphones, mice, touchpads, keyboards, or any other interface providing a mechanism for user input.

In various aspects provided herein, the resulting data may include various types of information associated with information provided by messages decoded by the communication processor 218 received via designated messaging architectures, such as V2X, ITS, etc. for the control operations of the control system 200 of the vehicle 100, illustratively, for the control of the mobility system 120. In some examples, the data acquisition processor 214 processor may also access the information provided by the messages for its operations.

In some examples, the communication processor 218 may include a digital signal processor and/or a controller which may direct such communication functionality of vehicle 100 according to various communication protocols associated with wired communication protocols, such as universal serial bus (USB) protocol for data communication etc., with various types of devices connected to a port coupled to the communication processor 218. In particular, in accordance with various aspects provided herein, the port may be configured to be coupled to a mobile communication device, such as a mobile phone or a smartphone to transfer data between the control system 200 and the mobile communication device.

The communication processor 218 may include a digital signal processor and/or a controller which may direct such communication functionality of vehicle 100 according to the communication protocols associated with one or more radio access networks, and may execute control over antenna system 106 and RF transceiver(s) 108 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of vehicle 100 shown in FIGS. 1 and 2 may depict only a single instance of such components.

Vehicle 100 may transmit and receive wireless signals with antenna system 106, which may be a single antenna or an antenna array that includes multiple antenna elements. Antenna system 202 may additionally include analog antenna combination and/or beamforming circuitry. In the receive (RX) path, RF transceiver(s) 108 may receive analog radio frequency signals from antenna system 106 and perform analog and digital RF front-end processing on the analog radio frequency signals to produce digital baseband samples (e.g., In-Phase/Quadrature (IQ) samples) to provide to communication processor 218. RF transceiver(s) 108 may include analog and digital reception components including amplifiers (e.g., Low Noise Amplifiers (LNAs)), filters, RF demodulators (e.g., RF IQ demodulators)), and analog-to-digital converters (ADCs), which RF transceiver(s) 108 may utilize to convert the received radio frequency signals to digital baseband samples. In the transmit (TX) path, RF transceiver(s) 108 may receive digital baseband samples from communication processor 218 and perform analog and digital RF front-end processing on the digital baseband samples to produce analog radio frequency signals to provide to antenna system 106 for wireless transmission. RF transceiver(s) 108 may thus include analog and digital transmission components including amplifiers (e.g., Power Amplifiers (PAs), filters, RF modulators (e.g., RF IQ modulators), and digital-to-analog converters (DACs), which RF transceiver(s) 108 may utilize to mix the digital baseband samples received from communication processor 218 and produce the analog radio frequency signals for wireless transmission by antenna system 106. Communication processor 218 may control the radio transmission and reception of RF transceiver(s) 108, including specifying the transmit and receive radio frequencies for operation of RF transceiver(s) 108.

Communication processor 218 may include a baseband modem configured to perform physical layer (PHY, Layer 1) transmission and reception processing to, in the transmit path, prepare outgoing transmit data provided by communication processor 218 for transmission via RF transceiver(s) 108, and, in the receive path, prepare incoming received data provided by RF transceiver(s) 108 for processing by communication processor 218. The baseband modem may include a digital signal processor and/or a controller. The digital signal processor may be configured to perform one or more of error detection, forward error correction encoding/decoding, channel coding, and interleaving, channel modulation/demodulation, physical channel mapping, radio measurement and search, frequency and time synchronization, antenna diversity processing, power control, and weighting, rate matching/de-matching, retransmission processing, interference cancelation, and any other physical layer processing functions. The digital signal processor may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components.

In some aspects, the digital signal processor may include one or more processors configured to retrieve and execute program code that defines control and processing logic for physical layer processing operations. In some aspects, the digital signal processor may execute processing functions with software via the execution of executable instructions. In some aspects, the digital signal processor may include one or more dedicated hardware circuits (e.g., ASICs, FPGAs, and other hardware) that are digitally configured to specific execute processing functions, where the one or more processors of digital signal processor may offload specific processing tasks to these dedicated hardware circuits, which are known as hardware accelerators. Exemplary hardware accelerators can include Fast Fourier Transform (FFT) circuits and encoder/decoder circuits. The digital signal processor's processor and hardware accelerator components may be realized as a coupled integrated circuit in some aspects.

RF transceiver(s) 108 may include separate RF circuitry sections dedicated to different respective radio communication technologies, and/or RF circuitry sections shared between multiple radio communication technologies. Antenna system 106 may include separate antennas dedicated to different respective radio communication technologies, and/or antennas shared between multiple radio communication technologies. Accordingly, antenna system 106, RF transceiver(s) 108, and communication processor 218 can encompass separate and/or shared components dedicated to multiple radio communication technologies.

Vehicle 100 may be configured to operate according to one or more radio communication technologies. The digital signal processor of the communication processor 218 may be responsible for lower-layer processing functions (e.g., Layer 1/PHY) of the radio communication technologies. In contrast, a controller of the communication processor 218 may be responsible for upper-layer protocol stack functions (e.g., Data Link Layer/Layer 2 and/or Network Layer/Layer 3). The controller may thus be responsible for controlling the radio communication components of vehicle 100 (antenna system 106, RF transceiver(s) 108, position device 114, etc.) in accordance with the communication protocols of each supported radio communication technology, and accordingly may represent the Access Stratum and Non-Access Stratum (NAS) (also encompassing Layer 2 and Layer 3) of each supported radio communication technology. The controller may be structurally embodied as a protocol processor configured to execute protocol stack software (retrieved from a controller memory) and subsequently control the radio communication components of vehicle 100 to transmit and receive communication signals in accordance with the corresponding protocol stack control logic defined in the protocol stack software. The controller may include one or more processors configured to retrieve and execute program code that defines the upper-layer protocol stack logic for one or more radio communication technologies, which can include Data Link Layer/Layer 2 and Network Layer/Layer 3 functions. The controller may be configured to perform both user-plane and control-plane functions to facilitate the transfer of application layer data to and from vehicle 100 according to the specific protocols of the supported radio communication technology. User-plane functions can include header compression and encapsulation, security, error checking and correction, channel multiplexing, scheduling, and priority, while control-plane functions may include setup and maintenance of radio bearers. The program code retrieved and executed by the controller of communication processor 218 may include executable instructions that define the logic of such functions.

In some aspects, vehicle 100 may be configured to transmit and receive data according to multiple radio communication technologies. Accordingly, in some aspects, one or more of antenna system 106, RF transceiver(s) 108, and communication processor 218 may include separate components or instances dedicated to different radio communication technologies and/or unified components that are shared between different radio communication technologies. For example, in some aspects, multiple controllers of communication processor 218 may be configured to execute multiple protocol stacks, each dedicated to a different radio communication technology and either at the same processor or different processors. In some aspects, multiple digital signal processors of communication processor 218 may include separate processors and/or hardware accelerators that are dedicated to different respective radio communication technologies, and/or one or more processors and/or hardware accelerators that are shared between multiple radio communication technologies. In some aspects, RF transceiver(s) 108 may include separate RF circuitry sections dedicated to different respective radio communication technologies, and/or RF circuitry sections shared between multiple radio communication technologies. In some aspects, antenna system 106 may include separate antennas dedicated to different respective radio communication technologies, and/or antennas shared between multiple radio communication technologies. Accordingly, antenna system 106, RF transceiver(s) 108, and communication processor 218 can encompass separate and/or shared components dedicated to multiple radio communication technologies.

Communication processor 218 may be configured to implement one or more vehicle-to-everything (V2X) communication protocols associated with how information is exchanged between vehicles, infrastructure, networks, pedestrians, and other devices. These protocols may include various rules, formats, and procedures for data transmission, ensuring interoperability and standardized communication. Protocols within C-V2X may include standards like IEEE 802.11p (for Dedicated Short-Range Communications, DSRC), Cellular-V2X (C-V2X) based on 3GPP standards (Release 14/15), and future developments aligned with 5G technologies.

In accordance with various aspects described herein, the communication processor 218 may obtain traffic-related information provided via V2X communication through various services enabled by these protocols. These services may be associated with practical applications and capabilities that result from the exchange of information among vehicles, infrastructure elements, networks, pedestrians, and other devices. Such services may facilitate an exchange of various types of traffic-related information, which the control system 200 may take as input and perform its control operations according to those traffic-related information elements.

Illustratively, such services may include vehicle-to-vehicle (V2V) services, in which the communication processor 218 may decode service information shared by other vehicles, which the information may include information about, each being an illustrative service information element: speed, location, direction, accident warnings, sudden braking warnings, road hazards, and further traffic-related information to enhance safety and traffic efficiency. The communication processor 218 may also encode similar self-service information to be sent to other vehicles.

Such services may further include vehicle-to-infrastructure (V2I) services, in which the communication processor 218 may decode service information shared by traffic infrastructure entities, such as, each being an illustrative service information element: traffic lights, signages, road sensors, etc., which the information may include information about road conditions, traffic congestions, upcoming obstacles, etc. The communication processor 218 may also encode similar self-service information to be sent to traffic infrastructure entities.

Such services may further include vehicle-to-pedestrian (V2P) services, in which the communication processor 218 may decode service information shared by mobile communication devices of pedestrians (e.g. mobile phones, smartphones, wearables, etc.), such as information, each being an illustrative service information element: about presence and location of the pedestrians. The communication processor 218 may also encode similar self-service information to be sent to pedestrian devices.

Such services may further include vehicle-to-network (V2N) services, in which the communication processor 218 may decode service information shared by network structures, such as servers, cloud services, etc. The information may include information about, each being an illustrative service information element: maps, road maps, traffic information, weather information, infotainment systems related information, software updates, and other cloud-based services, which may be used to improve navigation and driving experience of the vehicle.

Communication processor 218 may be configured to operate via a first RF transceiver of the one or more RF transceivers(s) 108 according to different desired radio communication protocols or standards. By way of example, communication processor 218 may be configured according to a Short-Range mobile radio communication standard such as, e.g., Bluetooth, Zigbee, and the like first RF transceiver may correspond to the corresponding Short-Range mobile radio communication standard. As another example, communication processor 218 may be configured to operate via a second RF transceiver of the one or more RF transceivers(s) 108 in accordance with a Medium or Wide Range mobile radio communication standard such as, e.g., a 3G (e.g., Universal Mobile Telecommunications System—UMTS), a 4G (e.g., Long Term Evolution—LTE), or a 5G mobile radio communication standard in accordance with corresponding 3GPP (3rd Generation Partnership Project) standards. As a further example, communication processor 218 may be configured to operate via a third RF transceiver of the one or more RF transceivers(s) 108 in accordance with a Wireless Local Area Network communication protocol or standard such as, e.g., in accordance with IEEE 802.11 (e.g., 802.11, 802.11a, 802.11b, 802.11g, 802.11n, 802.11p, 802.11-12, 802.11ac, 802.11ad, 802.11ah, and the like). The one or more RF transceiver(s) 108 may be configured to transmit signals via antenna system 106 over an air interface. The RF transceivers 108 may each have a corresponding antenna element of antenna system 106, or may share an antenna element of the antenna system 106.

Memory 104 may embody a memory component of vehicle 100, such as a hard drive or another such permanent memory device. Although not explicitly depicted in FIGS. 1 and 2, the various other components of vehicle 100, e.g. one or more processors 102, shown in FIGS. 1 and 2 may additionally each include integrated permanent and non-permanent memory components, such as for storing software program code, buffering data, etc.

The antenna system 106 may include a single antenna or multiple antennas. Each of the one or more antennas of antenna system 106 may be placed at a plurality of locations on the vehicle 100 in order to ensure maximum RF coverage. The antennas may include a phased antenna array, a switch-beam antenna array with multiple antenna elements, etc. Antenna system 106 may be configured to operate according to analog and/or digital beamforming schemes in order to maximize signal gains and/or provide levels of information privacy. Antenna system 106 may include separate antennas dedicated to different respective radio communication technologies, and/or antennas shared between multiple radio communication technologies.

While shown as a single element in FIG. 1, antenna system 106 may include a plurality of antenna elements (e.g., multiple antenna arrays) positioned at different locations on vehicle 100. The placement of the plurality of antenna elements may be strategically chosen in order to ensure a desired degree of RF coverage. For example, additional antennas may be placed at the front, back, corner(s), and/or on the side(s) of the vehicle 100.

Data acquisition devices 112 may include any number of data acquisition devices and components, including sensors, depending on the requirements of a particular application. This may include force sensors, load cells, image acquisition devices, proximity detectors, acoustic sensors, pressure sensors, fingerprint sensors, motion detectors, etc., for providing data about the interior of the vehicle or the vehicle's environment. Image acquisition devices may include cameras (e.g., multimodal cameras, standard cameras, digital cameras, video cameras, single-lens reflex cameras, infrared cameras, stereo cameras, depth cameras, RGB cameras, depth cameras, etc.), charge coupling devices (CCDs), or any type of image sensor. Proximity detectors may include radar sensors, light detection and ranging (LIDAR) sensors, mmWave radar sensors, etc. Acoustic sensors may include microphones, sonar sensors, ultrasonic sensors, etc. Furthermore, the data acquisition devices may include the sensors coupled to the mobility system 120, such as the accelerometers, inertial measurement unit (IMU) sensors.

Accordingly, each of the data acquisition units may be configured to observe a particular type of data of an occupant of the vehicle 100 or the vehicle's 100 environment and forward the data to the data acquisition processor 214 in order to provide the vehicle with an accurate portrayal of the interior of the vehicle 100 or vehicle's 100 environment. The data acquisition devices 112 may be configured to implement pre-processed sensor data, such as radar target lists or LIDAR target lists, in conjunction with acquired data.

Measurement devices 116 may include other devices for measuring vehicle-state parameters, such as a velocity sensor (e.g., a speedometer) for measuring a velocity of the vehicle 100, one or more accelerometers (either single axis or multi-axis) for measuring accelerations of the vehicle 100 along one or more axes, a gyroscope for measuring orientation and/or angular velocity, odometers, altimeters, thermometers, etc. It is appreciated that vehicle 100 may have different measurement devices 116 depending on the type of vehicle it is, e.g., car vs. drone vs. boat.

Position devices 114 may include components for determining a position of the vehicle 100. For example, this may include GPS or other GNSS circuitry configured to receive signals from a satellite system and determine a position of the vehicle 100. Position devices 114, accordingly, may provide vehicle 100 with satellite navigation features. The one or more position devices 114 may include components (e.g., hardware and/or software) for determining the position of vehicle 100 by other means, e.g. by using triangulation and/or proximity to other devices such as NIEs.

The one or more memories 104 may store data, e.g., in a database or in any different format, that may correspond to a map. For example, the map may indicate a location of known landmarks, roads, paths, network infrastructure elements, or other elements of the vehicle's 100 environment. The one or more processors 102 may process sensory information (sensor data including information such as force measurements, images, sensor readings, radar signals, depth information from LIDAR, or stereo processing of two or more images) of the environment of the vehicle 100 together with position information, such as GPS coordinates, a vehicle's ego-motion, etc., to determine a current location of the vehicle 100 relative to the known landmarks, and refine the determination of the vehicle's location. Certain aspects of this technology may be included in a localization technology such as a mapping and routing model.

The map database (DB) 204 may include any type of database storing (digital) map data for the vehicle 100, e.g., for the control system 200. The map database 204 may include data relating to the position, in a reference coordinate system, of various items, including roads, water features, geographic features, businesses, points of interest, restaurants, gas stations, etc. The map database 204 may store the locations of such items and descriptors relating to those items, including, for example, names associated with any of the stored features. In some aspects, a processor of the one or more processors 102 may download information from the map database 204 over a wired or wireless data connection to a communication network (e.g., over a cellular network and/or the Internet, etc.). In some cases, the map database 204 may store a sparse data model including polynomial representations of certain road features (e.g., lane markings) or target trajectories for the vehicle 100. The map database 204 may also include stored representations of various recognized landmarks that may be provided to determine or update a known position of the vehicle 100 with respect to a target trajectory. The landmark representations may include data fields such as landmark type, landmark location, among other potential identifiers.

Furthermore, the control system 200 may include a driving model, e.g., implemented in an advanced driving assistance system (ADAS) and/or a driving assistance and automated driving system. By way of example, the control system 200 may include (e.g., as part of the driving model) a computer implementation of a formal model such as a safety driving model. A safety driving model may be or include a mathematical model formalizing an interpretation of applicable laws, standards, policies, etc. that are applicable to self-driving vehicles. A safety driving model may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic and in turn limit the scalability of system deployment; and third, the interpretation should be efficiently verifiable in the sense that it can be rigorously proven that the self-driving (autonomous) vehicle correctly implements the interpretation of the law. A safety driving model, illustratively, may be or include a mathematical model for safety assurance that enables identification and performance of proper responses to dangerous situations such that self-perpetrated accidents can be avoided.

As described above, the vehicle 100 may include the control system 200 as also described with reference to FIG. 2. The vehicle 100 may include the one or more processors 102 integrated with or separate from an engine control unit (ECU) which may be included in the mobility system 120 of the vehicle 100. The control system 200 may, in general, generate data to control or assist to control the ECU and/or other components of the vehicle 100 to directly or indirectly control the movement of the vehicle 100 via mobility system 120. The one or more processors 102 of the vehicle 100 may be configured to perform as described herein.

In accordance with various aspects described herein, the vehicle 100 may include a carrier structure. The carrier structure may be any type of structure that suitable for a vehicle to carry a load. The load may be any object or collection of objects that the vehicle 100 is designed to transport. In some examples, the load may be an object that is external to the vehicle 100, such as a package, a pallet, a box, etc. that has no integrated portion to the vehicle 100. In some examples, the load may be an internal and/or integrated object to the vehicle 100, such as a particular volume including one or more components of the vehicle 100. The carrier structure may include a load-bearing platform. The load-bearing platform may be equipped with multiple force sensors positioned at predetermined coordinates. In some examples, each force sensor may be configured for multi-axis measurements for detection of forces in longitudinal, vertical, and traverse directions. The force sensors may generate electrical signals corresponding to the measured forces, which the one or more processors 102 of the vehicle 100 may process the measurements to determine the load's COG.

The carrier structure may take several forms, depending on the specific application and the type of load anticipated. The carrier structure may include a substantially flat, rigid platform. This platform may be constructed from materials such as aluminum (e.g., 6061-T6 alloy), steel (e.g., A36 steel), high-strength polymers (e.g., reinforced polycarbonate or ABS), or composite materials (e.g., carbon fiber reinforced polymer). The platform's dimensions may be arranged according to the intended load capacity and the overall size of the vehicle 100. For example, a platform for a smaller vehicle (e.g. AMR) might be 500 mm×500 mm, while a larger vehicle (e.g. AGV) might have a platform of 1500 mm×1000 mm or larger. The thickness of the platform may be arranged to be sufficient to withstand the maximum anticipated load without significant deflection. For example, a 10 mm thick aluminum platform might be suitable for loads up to 500 kg, while a 25 mm thick steel platform might be used for loads exceeding 1000 kg. The platform surface may be treated to increase friction (e.g., with a textured coating or rubberized mat) to prevent load slippage.

In an example, the carrier structure may be contoured or shaped to accommodate specific load types. For example, the carrier structure may have recesses or protrusions to securely hold cylindrical objects, pallets, or specialized containers. The materials and construction may be as described above, but the geometry of the carrier structure can be tailored to the specific application. For example, the carrier structure may be a modular carrier structure including multiple interconnected sections. These sections may be rearranged or added/removed to adapt to different load sizes and shapes. The sections might connect using interlocking mechanisms, quick-release fasteners, or other suitable joining methods. Each module may have its own set of force sensors for distributed load sensing. In an example, the carrier structure may include a frame-like structure rather than a solid platform. This frame may be constructed from welded or bolted metal members (e.g., square or rectangular tubing) to provide strength and rigidity while minimizing weight.

The components illustrated in FIGS. 1 and 2 may be operatively connected to one another via any appropriate interfaces. Furthermore, it is appreciated that not all the connections between the components are explicitly shown, and other interfaces between components may be covered within the scope of this disclosure.

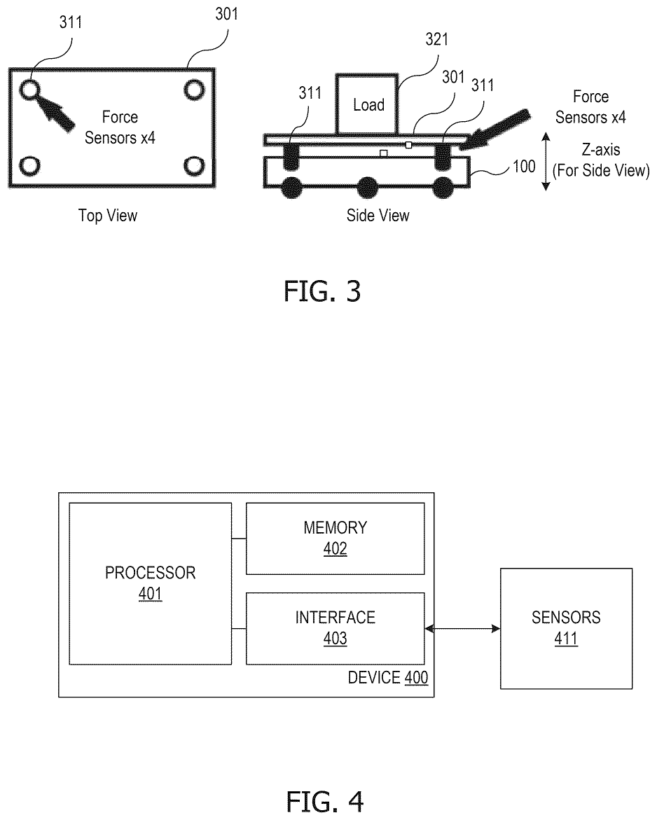

FIG. 3 illustrates an illustration of a vehicle in accordance with various aspects described herein. In this illustration, the vehicle (e.g. the vehicle 100) includes a carrier structure 301 and force sensors 311, which may be employed in determining the three-dimensional COG (COG) of a load represented to be carried by the vehicle 100.

The carrier structure 301, serving as a load-bearing platform, may be configured to support a load 321 securely during movement. Illustratively, the load-bearing platform may include a flat surface designed to accommodate loads of various shapes and sizes. The load-bearing platform may be arranged, such that the weight of the load 321 is evenly distributed. The carrier structure 301 may form a part of the overall vehicle 100 and may be mechanically linked to the vehicle's chassis. Illustratively, the carrier structure 301 may move in synchronization with the vehicle 100 during the operation of the vehicle 100.

The vehicle may include a number of force 311 sensors to measure forces applied (i.e. exerted) on them by the load 321. The force sensors 311 may measure forces applied on at least one axis that is the axis along which gravitational forces are to be present in accordance with the configuration of the carrier structure 301 (e.g. placement of load 321 within the carrier structure) and the vehicle 100 (e.g. direction of movement, placement of the carrier structure, etc.). In some examples, the force sensors 311 may measure forces applied on at least two axes, or three axes of a three dimensional space, each axis being perpendicular to others. Illustratively, there are four force sensors 311 positioned on the carrier structure 301, as shown in both the top and side views. In an example, the force sensors 311 may be load cells configured to measure forces exerted on them by the load 321. Each force sensor 311 may convert the mechanical force it experiences, some of which may include gravitational force, into an electrical signal that represents the magnitude and direction of the force. The force sensors 301 may be situated at known and predefined coordinates on the carrier structure 301, and configured to reflect the load distribution across the platform.

For example, the force sensors 311 may be strain gauge load cells. They may utilize strain gauges bonded to a deformable element. When the load 321 applies a force, the element deforms, changing the strain gauge's resistance. This change is measured, for example using a Wheatstone bridge circuit, producing an output voltage proportional to the force. Load cells may be available in various load ratings (e.g., 10 kg, 50 kg, 100 kg, 500 kg, 1000 kg) and accuracy classes (e.g., 0.1%, 0.05%, 0.02% of full scale). Alternatively, the force sensors may be piezoelectric force sensors that use the piezoelectric effect, generating a charge proportional to the applied force. Such sensors can offer high sensitivity and a wide frequency response but can be more susceptible to temperature changes. In another example, the force sensors 311 may be capacitive force sensors that measure the change in capacitance between two plates as the force changes the distance between them.

To determine the COG of the load 321, at least two force sensors 311 may be positioned on the carrier structure 301 of the vehicle 100. The force sensors 311 may be disposed beneath the carrier structure 301 and may be arranged to measure the forces exerted by the load 321. These forces may include the weight of the load 321 and any additional forces resulting from the movement of the vehicle 100 and/or from the movement of the carrier structure or the load 321. The force sensor 311 data may be processed by the one or more processors 102 (e.g. the data acquisition processor 214). The arrangement may allow for the measurement of the load distribution and the calculation of the COG's position in three dimensions (X, Y, and Z).

As illustrated in FIG. 3, an arrangement may include four force sensors 311, one positioned near each corner of the carrier structure 301. This configuration can provide a robust and accurate determination of the COG, particularly for loads that may not be evenly distributed. The known and predefined coordinates of each force sensor 311 on the carrier structure 301 may be used by the one or more processors 310 for the COG calculations. For example, if the carrier structure 301 is a rectangle with dimensions L×W, the sensors 311 can be located at coordinates (±L/2±εx, ±W/2±εy), where εx and εy represent small offsets from the exact corners to accommodate mechanical mounting constraints. Each of the four force sensors 311 may be provided at their coordinates (x1, y1), (x2, y2), (x3, y3), (x4, y4) relative to a defined origin.

While four sensors can be arranged, a minimum of two force sensors 311 can be used. These sensors can typically be positioned along a diagonal of the carrier structure 301. For example, one sensor might be located near the front-left corner, and the other near the rear-right corner. This can provide sensitivity to both X and Y components of the COG, although it may be with reduced accuracy compared to the four-sensor configuration. For applications requiring higher accuracy or dealing with complex load shapes, an array of force sensors 311 (e.g., 3×3, 4×4, or larger) can be distributed beneath the carrier structure 301, which may facilitate a more detailed map of the force distribution. The one or more processors 102 may process the data from all sensors to determine the COG. In some examples, the spacing between sensors can be uniform (e.g., a regular grid) or non-uniform, depending on the specific requirements. The specific coordinates of the sensors would be known and used in the COG calculations.

The load 321, which may be positioned atop the carrier structure 301, may be any object or package that the vehicle 100 is designed to transport. Properties of the load, including weight, size, and height, may vary, which may influence the distribution of forces detected by the sensors 311. In scenarios involving dynamic loads, such as shifting cargo or irregularly shaped objects, the configuration illustrated may allow for continuous monitoring of the forces acting on the carrier structure 301. From the side view depicted in the image, the force sensors 311 may be positioned not only to measure the planar (X and Y axes) distribution of weight but also to provide data that may be used to calculate the vertical (Z-axis) position of the COG as described herein.

In accordance with various aspects described herein, the carrier structure 301 may be movable relative to the vehicle (e.g. to the chassis of the vehicle to which the carrier structure is mechanically linked). Especially, the carrier structure 301 may be configured to be tiltable. The term “tiltable” may refer to that the carrier structure 301 is capable of being rotated about a horizontal axis. This rotation may be controlled, temporary, and reversible. The term “tiltable” used herein may not simply refer to a matter of the platform being loose or unstable; but to a deliberate and precise change in the platform's orientation relative to the horizontal plane (i.e., the ground). The carrier structure 301 being tiltable may refer to that the carrier structure 301 may rotate around a pivot point around one or more horizontal axes in a controlled manner. The rotation may be achieved with one or more actuators.

A carrier structure controller, which may the one or more processors 102 (e.g., implemented within the application processor 216 or a dedicated microcontroller) may include, can control the actuators. In accordance with various aspects described herein, by measuring the force sensors 311 readings at different, known tilt angles, the height of the COG can be calculated.

In an example, two linear actuators can be positioned along one axis (e.g., the Y-axis, or lateral axis, of the vehicle 100) and may be spaced apart. By extending one actuator more than the other, the carrier structure 301 can tilt about an axis perpendicular to the actuator axis (e.g., the X-axis, or longitudinal axis). For example, actuators may include electric linear actuators with ball screws or lead screws for their precision and controllability. The actuators may typically include built-in position feedback (e.g., encoders or potentiometers), which can provide precise information about the actuator's extension and, therefore, the tilt angle, which the one or more processors 102 may determine. In another example, a single linear actuator can tilt the carrier structure 301 about a fixed pivot point. This may be a simpler mechanism but may have a limited tilt range. The pivot point can include a defined mechanical hinge or bearing. The actuator's position and the geometry of the linkage determine the tilt angle, which the one or more processors 102 may determine. In an example, at least three actuators may provide greater flexibility, to allow tilting about both the X and Y axes, which may be useful for loads with complex shapes or when the COG location is highly uncertain. In examples, actuators described herein may include servo motors with gearbox. Such rotary actuators, specifically servo motors coupled with gearboxes, can offer another way to achieve precise tilting. In those examples, the gearbox increases the torque output of the servo motor, which enables it to lift the loaded carrier structure 301. In some examples, the servo motor's internal encoder may provide angular position feedback to the one or more processors, which may determine the present tilt angle.

In some examples, the carrier structure controller may receive commands (e.g., desired tilt angle) from the one or more processors 102 (e.g. the application processor 216) and may generate the control signals for the actuators. This control may involve a closed-loop control. For example, the carrier structure controller may receive the position feedback from the actuators (encoders, potentiometers, or internal servo feedback) as described above to determine actual tilt angle of the carrier structure (e.g. relative to at least one axis of the horizontal plane). In some examples, the carrier structure controller may compare the desired tilt angle with the actual tilt angle. The carrier structure controller may employ a control algorithm (e.g., PID control) to generate the appropriate control signals (e.g., voltage or PWM signals) for the actuators to minimize the error between the desired tilt angle and the actual tilt angle. The control signals may drive the actuators (e.g., through motor drivers or H-bridges).

In accordance with various aspects described herein, the carrier structure controller may be configured to adjust the carrier structure 301 to at least two distinct tilt angles relative to the horizontal plane. For instance: Tilt Angle 1: θ1=+5 degrees (relative to horizontal) and Tilt Angle 2: θ2=−5 degrees (relative to horizontal). In accordance with various aspects, the one or more processors 102 may use the force sensor readings at these two (or more) tilt angles in the COG height calculation. The tilting motion may be performed slowly and smoothly to avoid dynamic effects that could distort the force measurements. In an example, the one or more processors 102 may wait for the force readings to stabilize at each tilt angle before using corresponding data for COG height calculations.

FIG. 4 shows an illustrative example of device 400 for the vehicle 100 schematically, in accordance with various aspects of the disclosure. The device 400 may include a processor 401 (e.g. the one or more processors 102, the communication processor 218, the application processor 216, the data acquisition processor 214), a memory 402 (e.g. the memory 104), and an interface 403. The interface 403 may include any component configured to perform a communication operation to at least receive signals sent by sensors 411. The sensors 411 may include force sensors (e.g. the force sensors 311). Illustratively, the interface 403 may include a radio communication circuit (e.g. the RF transceiver 108) or an internal communication bus, which may communicatively couple the sensors 411 with the processor 401. The device 400 may obtain signals, which may be referred to as sensor data, sent by the sensors 411.

Illustratively, the interface 403 may couple the device 400 communicatively to the sensors 411 via an established connection between the device 400 and the sensors 411. In some examples, the established connection may be a wireless connection, and the interface 403 may be one of the communication interfaces as described above including an RF transceiver 108, the antenna system 106. In some examples, the established connection may be a wired connection, and the interface 404 may include a port configured to couple the sensors 411 via a cable. For example, the wired connection may include a USB connection, or any other connection that is fit to couple the sensors 411 to the device 400 communicatively for exchange of information.

The processor 401 may include one or more processing means. In various examples, the processor 401 may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 401 may be implemented in one processing unit, e.g. a system on chip (SOC), or a processor. In some examples the processor 401 may include one or more cores as computation units, an arithmetic logic unit, a control unit, a storage unit, a plurality of registers. In some examples, the mobile communication device may provide information to the memory 402 that is accessible by the processor 401.

As described herein, the sensors 411 may include force sensors 411 configured to to measure forces applied (i.e. exerted) on them by a load (e.g. the load 321). Although the load has been illustrated as a single unit, the load may include multiple units, pieces, particles, and can be of any shape. Illustratively, a carrier structure (e.g. the carrier structure 301) of the vehicle 100 may be configured to carry the load and the force sensors 411 may measure forces applied on at least one axis that is the axis along which gravitational forces are to be present in accordance with the configuration of the carrier structure. This axis may be referred to as Z-axis herein. In some examples, the force sensors 411 may measure forces applied further on X axis and/or Y axis as well, each axis being perpendicular to others. In an example, the force sensors 411 may be load cells configured to measure forces exerted on them by the load.

In an example, the interface 403 may receive sensor data representing force measurements from at least two force sensors 411. Illustratively, the force sensors 411 may be positioned on the carrier structure of the vehicle. The interface 403 may serve as a communication gateway between the force sensors 411 and the processor 401 to collect force measurement data from multiple sensors installed on the carrier structure. Operationally, the interface 403 may acquire real-time force measurements that reflect the load applied to the carrier structure. The input to the interface 403 may include electrical signals or data packets generated by the force sensors 411, and the output may include a processed data stream forwarded to the processor 401 for further analysis.

The interface 403 can be implemented physically as a wired or wireless communication module. In one embodiment, it includes analog-to-digital converters to process analog signals from strain gauge-based force sensors 411. Alternatively, it could be a digital interface compatible with sensors that provide digital outputs, such as those using I2C or SPI protocols. The interface 403 may be configured with multiplexing capabilities to handle inputs from multiple sensors simultaneously and might include signal conditioning circuits to filter noise and ensure data integrity.

In an example, the processor 401 may determine sensor positions of the at least two sensors along a horizontal plane. For example, the interface 403 may be configured to receive sensor data representing force measurements along at least a first axis (Z-axis) of the vehicle from at least two sensors 411. The interface 403 may facilitate communication between the sensors and the processor 401 and may enable the device 400 to acquire information representing force measurements real-time force measurements, which may be referred to herein as sensor data.

The processor 401 may determine the positions of the at least two sensors 411 along a second axis and a third axis, wherein the second axis and the third axis are perpendicular to the first axis. The first axis being referred to as Z-axis, the second and third axes may be referred to as X and Y axes. Correspondingly, the processor 401 may use the spatial arrangement of the sensors indicated by their positions as part of the calculation of the load's COG. The X and Y axes may correspond to horizontal directions relative to the vertical direction of Z-axis, the sensor positions may be defined at X-Y axes, which may also correspond to vehicle's movement at horizontal direction. In some examples, the determined positions may include relative positions (e.g. one force sensor being taken as the origin). In some examples, certain axis or axes of the sensor positions may be taken as zero. In an example, the processor 401 may determine the positions of the at least two sensors 411 based on sensor position data stored in the memory 402 (e.g. information indicating predefined or predetermined positions of the at least two sensors). In some examples, the processor 401 may dynamically detect or determine the sensor positions through calibration or user input.

In an example, the processor 401 may calculate the locations of the force sensors 411 relative to a defined horizontal plane within the vehicle's coordinate system, which may be the horizontal plane referred to herein. Operationally, the processor 401 may retrieve pre-stored positional data or compute positions based on sensor inputs. The input may include sensor identifiers and reference points, and the output may include the spatial coordinates—such as x and y positions—of each sensor 411. In an example, sensor positions may be stored in a lookup table within the memory 402 or calculated using geometric relationships if the sensors 411 are movable. Additionally, or alternatively, the processor 401 may determine the positions with a global positioning system (GPS) module for sensors spread over larger areas, like in heavy machinery.

The processor 401 may be configured to determine the COG location of the load carried by the carrier structure (i.e. the load applying force to the at least two sensors 411) through measurements of the sensors 411 and calculations utilizing a controlled tilting operation. In operation, the processor 401 may receive, via the interface 403, force measurement data from the force sensors 411. The sensors 411 may be positioned at predetermined locations on the carrier structure (i.e. sensor positions). These force sensors 411 may be arranged in a symmetrical pattern, for example, at the corners of a rectangular carrier structure, or in an asymmetrical configuration optimized for particular load distributions. Illustratively, each force sensor 411 may be calibrated to measure forces with a precision of at least 0.1% of the full-scale range (e.g., between 0 and 1000 kilograms), ensuring accurate load measurement across a wide range of operating conditions.

The processor 401 may maintain in memory 402 a coordinate mapping of the positions of each force sensor 411 relative to a reference point on the carrier structure. This data may be referred to as sensor position information. Illustratively, the sensor position information may be stored as a set of Cartesian coordinates (x, y) in the horizontal plane, with each sensor position typically defined with a designated precision (e.g. submillimeter precision). In some examples, the reference point may be chosen as the geometric center of the carrier structure, the position of a particular force sensor, or any other convenient point in the horizontal plane. The processor 401 may periodically validate these stored positions through self-calibration routines or update them based on maintenance data to ensure continued accuracy of COG calculations.

In an example, the processor 401 may instruct a carrier structure controller to adjust an orientation of the carrier structure. The adjustment of the orientation of the carrier structure may include an adjustment of the carrier structure to at least two tilt angles relative to the horizontal plane. The processor 401 may direct the carrier structure controller to modify the orientation of the carrier structure by tilting it to specified angles. This adjustment can facilitate the measurement of force variations under different inclinations, which may be used for calculating the load's COG. The processor 401 may provide or determine inputs including the desired tilt angles, and may output control signals sent to actuators that adjust the carrier structure. The processor 401 may generate control commands compatible with the carrier structure controller's interface. For example, the processor 401 may utilize pulse-width modulation (PWM) signals or digital commands over a communication bus. The carrier structure controller may be a part of an electronic control unit (ECU) that is configured to manage hydraulic or electric actuators responsible for tilting the structure.

In an example, the processor 401 may activate preset tilt positions of the carrier structure via the control signals. In some examples, the processor 401 may adjust the tilt angles dynamically using feedback from inclinometers to achieve desired angles. For this purpose, the processor 401 may communicate with the carrier structure controller.

To facilitate the determination of the load's COG height (i.e. COG location along an axis perpendicular to the horizontal plane, e.g. along the z-axis), which may also be referred to as the vertical COG location, the processor 401 may instruct the carrier structure controller to adjust the carrier structure to at least two tilt angles relative to the horizontal plane. For example, the processor 401 may communicate with a carrier structure controller to execute a designated tilting sequence. The carrier structure controller may include dedicated controllers (e.g. microcontrollers) external to the processor 401 or may be integrated within the processor 401 itself. The tilting sequence indicated here may include adjusting the carrier structure to at least two distinct tilt angles relative to the horizontal plane. These tilt angles may range from 0 degree to 15 degrees, more specifically angles between 3 and 8 degrees. In some examples, the processor 401 may select the tilt angles be selected based on factors including the load capacity, structural limitations, and required measurement precision.

In accordance with various aspects described herein, the vehicle may achieve the tilting operation through various mechanical implementations. For example, the carrier structure controller may manage two or more actuators (e.g. linear actuators) positioned at different points along the carrier structure. These actuators may be electric, hydraulic, or pneumatic, with position feedback capabilities providing control over the tilt angle. The actuators may operate with position resolution of 0.1 millimeters or better, to enable precise and repeatable tilt angle adjustments. In an example, the tilting mechanism may employ a combination of rotary actuators and linkage mechanisms to achieve the desired angular adjustments. During the tilting sequence, the processor 401 may continuously receive force measurement data from the sensors 411 through the interface 403. The processor 401 may apply various filtering techniques to the raw sensor data to reduce noise and improve measurement accuracy. These techniques may include moving average filters, Kalman filters, or other digital signal processing methods optimized for force measurement applications.

For each tilt angle, which has been set by the carrier structure, the processor 401 may calculate the load's COG projection onto the horizontal plane (i.e. horizontal COG location) using the force measurements and known sensor positions. This calculation may involve solving static equilibrium equations that relate the measured forces to the load's weight and its COG location. The processor 401 may employ various mathematical methods to solve these equations, including matrix operations, numerical optimization techniques, or closed-form solutions depending on the specific sensor configuration and required computational efficiency.

In an example, the processor 401 may determine a COG location along an axis perpendicular to the horizontal plane (i.e. vertical COG location) for the load applying force to the at least two sensors based on the sensor positions and the sensor data representing the force measurements at each tilt angle of the at least two tilt angles. Illustratively, by comparing the COG projections at different tilt angles, the processor 401 may determine the height of the COG of the load, which is above the carrier structure. This calculation may utilize trigonometric relationships between the tilt angles and the observed changes in the COG projections. The processor 401 may employ error estimation and uncertainty analysis techniques to assess the accuracy of the calculated height, typically achieving precision within 1-5% of the actual value under normal operating conditions.

The processor 401 may calculates the vertical COG location of the load relative to the carrier structure. By analyzing force measurements from sensors at different tilt angles and considering their positions, the processor may solve equations that relate these forces to the COG location along the vertical axis. For this purpose, the processor 401 may, based on inputs include sensor positions, determine force data at each tilt angle, and the tilt angles themselves. The processor 401 may output is a calculated COG height. In some examples, the processor 401 may implement machine learning algorithms trained to predict COG locations based on sensor data patterns.

The processor 401 may rely on input data from sensors and the tilt mechanism. In an example, the processor 401 may store historical COG data for trend analysis in the memory 402. The processor 401 may use mathematical models that relate force changes to COG movement. The processor 401 may calculate the COG height using equations based on principles of physics, such as moments and equilibrium conditions, which may be programmed into the processor 401. The processor 401 may access parameters like gravitational acceleration and the geometric configuration of the carrier structure from a stored information in the memory 402.

In some examples, the processor 401 may implement various compensation mechanisms to account for systematic errors and environmental factors. These may include temperature compensation for the force sensors 411, corrections for carrier structure deflection under load, and adjustments for any initial misalignment of the carrier structure relative to the horizontal plane. The processor 401 may also maintain a history of measurements to detect and correct for any drift or systematic errors in the measurement system. Throughout the measurement process, the processor 401 may continuously monitor the stability of the load and the integrity of the measurement system. This monitoring may include checking for sudden changes in force measurements that could indicate load shifting, verifying that all sensors are operating within their specified ranges, and ensuring that the tilting mechanism is functioning properly. If any anomalies are detected, the processor 401 may initiate appropriate safety responses, such as returning the carrier structure to a level position or generating warning signals.

In an example, the processor 401 may receive first sensor data representing first force measurements at a first tilt angle, instruct the carrier structure controller to adjust the carrier structure from the first tilt angle to a second tilt angle, receive second sensor data representing second force measurements at the second tilt angle, and determine the COG location based on the first force measurements and the second force measurements. In an example, the processor may perform these operations in a temporal order as described above. The processor 401 may implement a sequential measurement protocol that may coordinate the tilting operations with force data acquisition. During the first measurement phase, the processor 401 may acquire force measurements (e.g. at sampling rates between 100 Hz and 1000 Hz for a duration of 0.1 to 2 seconds) while maintaining the carrier structure at the first tilt angle.

The processor 401 may employ state management algorithms to ensure proper sequencing of operations. Before initiating any measurement sequence, the processor 401 may perform system readiness checks, including verifying sensor calibration status, checking actuator positions, and/or confirming communication link integrity with all system components. The processor 401 may implement data buffering mechanisms to store force measurements in temporary memory buffers.

In an example, the processor may instruct the carrier structure controller to adjust the carrier structure to the first tilt angle different from the second tilt angle before receiving the first sensor data. The processor 401 may implement a motion control sequence that may gradually adjust the carrier structure to the first tilt angle using controlled acceleration and deceleration profiles. These profiles may be implemented using S-curve trajectories with maximum acceleration rates typically between 0.1 and 2 degrees per second squared, ensuring smooth movement that minimizes load disturbance. The processor 401 may utilize real-time feedback from position sensors, such as encoders or inclinometers, to achieve a desired tilt angle accuracy.

For example, before initiating the tilting operation, the processor 401 may execute a pre-movement check sequence. This check may include verifying actuator readiness, checking hydraulic or pneumatic pressure levels if applicable, and confirming that all mechanical safety interlocks are properly engaged. The processor 401 may also implement predictive algorithms to estimate required actuator forces based on load weight and desired tilt angles to ensure that system capabilities are not exceeded.

In an example, the processor 401 may determine the first tilt angle based on first tilt angle measurements after the carrier structure has been adjusted to the first tilt angle. The processor 401 may further determine the second tilt angle based on second angle measurements after the carrier structure has been adjusted to the second tilt angle. For example, the processor 401 may utilize multiple angle measurement systems, potentially including both absolute and incremental encoders, MEMS-based inclinometers, and/or accelerometers, to achieve tilt angle measurements. The processor 401 may process these measurements using sensor fusion algorithms, such as complementary filters or extended Kalman filters, to combine data from multiple sensors.

In an example, the first tilt angle and the second tilt angle may be predetermined. The processor 401 may encode information representing the first tilt angle and the second tilt angle for a transmission to the carrier structure controller, to instruct the carrier structure controller to adjust the orientation of the carrier structure with those angles. The processor 401 may maintain a configuration database in memory 402, which may include predefined tilt angle pairs optimized for different load scenarios. For example, these angle pairs may be determined through empirical testing or theoretical analysis to maximize measurement accuracy while ensuring operational safety.

Before transmitting tilt angle commands, the processor 401 may perform parameter validation checks to ensure the requested angles fall within safe operating limits, typically between −15 and +15 degrees from horizontal. The processor 401 may also implement adaptive angle selection algorithms that adjust the predetermined angles based on factors such as load weight, load distribution, and environmental conditions.

In an example, if the notation is followed that the axis that is perpendicular to the horizontal plane being the first axis, the horizontal plane may be defined at a second axis and a third axis, which are perpendicular to the first axis. The processor 401 may implement a three-dimensional coordinate system management framework that may maintain relationships between multiple reference frames. This framework may include transformations between sensor-local coordinates, carrier structure coordinates, and vehicle-global coordinates, implemented using homogeneous transformation matrices. Before establishing coordinate relationships, the processor 401 may execute an initialization sequence that includes determining the gravity vector orientation using accelerometer measurements averaged over 1-2 seconds, establishing the horizontal plane perpendicular to this vector, and aligning the second and third axes with vehicle reference features. The

In accordance with various aspects described herein, the processor 401 may determine a horizontal COG location along at least one of the second axis and the third axis based on the sensor positions and the sensor data. The forces measured by the sensors 411 may reflect weight distribution across the horizontal plane of the carrier structure, which the processor 401 may use to calculate the horizontal COG components.

The processor 401 may determine the COG (COG) location along the second axis (X-axis) and the third axis (Y-axis) based on the sensor positions and the sensor data. This determination may especially performed together with the computation of the COG along the first axis (Z-axis) to enable a full three-dimensional representation of the load's COG. The processor 401 may use the positions of the sensors 411, which may be predefined or dynamically detected, to calculate the load distribution in the horizontal plane. For example, the processor 401 may retrieve the predefined positions of the sensors from the memory 402 or calibrate these positions using initial measurements. The processor 401 may analyze the sensor data representing force measurements from the sensors to determine the distribution of weight across the X-Y axes. In an example, the processor 401 may instruct the vehicle control system based on the distribution of weights indicated by the sensor data to change a parameter (e.g. velocity, spin, movement direction) associated with a movement of the vehicle to ensure that load or loads remain evenly distributed during transport, preventing lateral instability or uneven wear on the vehicle's components. The processor 401 may implement real-time calculation algorithms to process force sensor data to determine the load's COG projection onto the horizontal plane. These calculations may utilize weighted averaging methods that account for sensor positions and measured forces.

In an example, the processor 401 may determine the COG location along the first axis, the second axis, and the third axis based on the sensor positions relative to a predefined point of origin. The processor 401 may combine horizontal plane measurements with height calculations derived from tilt measurements, which may utilize numerical methods including singular value decomposition for solving overdetermined systems when multiple tilt angles are used, achieving typical accuracy of ±1% in all three dimensions.

In an example, the processor 401 may determine a first horizontal COG location along the at least one of the second axis and the third axis at the first tilt angle (i.e. when the carrier structure is adjusted to (i.e. oriented at) the first tilt angle). Furthermore, the processor 401 may determine a second horizontal COG location along the at least one of the second axis and the third axis at the second tilt angle (i.e. when the carrier structure is adjusted to (i.e. oriented at) the second tilt angle). The processor 401 may determine the COG location along the first axis based on the first horizontal COG location at the first tilt angle and the second horizontal COG location at the second tilt angle.

The processor 401 may process force measurements at each tilt angle independently before combining results to determine the COG height. In aspects, the processor 401 may calculate the COG height based on the first horizontal COG, the second horizontal COG, the first tilt angle, and the second tilt angle. The processor 401 may employ sophisticated geometric algorithms that account for the mathematical relationship between apparent COG shifts and actual height.

In an example, the processor 401 may determine the COG location along the first axis by calculating the first horizontal COG location at the first tilt angle, the second horizontal COG location at the second tilt angle using a set of equations. The processor 401 may implement a mathematical framework that may utilize both static equilibrium equations and geometric relationships to determine the COG height.

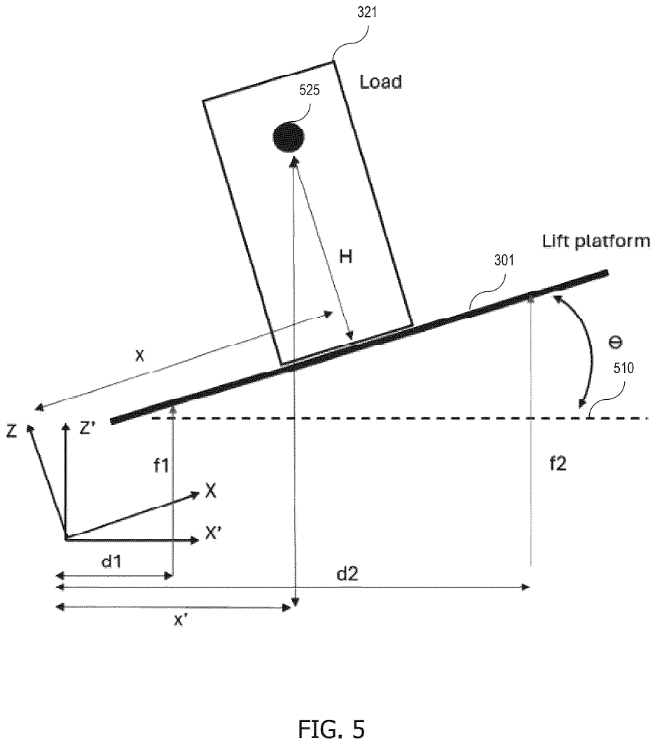

FIG. 5 shows an exemplary illustration of a carrier structure to carry the load. The carrier structure 301 and the load 321 depicted herein may correspond to aspects described in accordance with FIG. 3. Illustratively, two force sensors (e.g. load cells) may be disposed under the carrier structure 321 in a manner to measure forces at the vertical axis (corresponding to Z-axis described herein) for measuring the forces applied by the weight of the load 321. A device (e.g. the device 400) may be used to determine the COG of the load 321 positioned on a tiltable carrier structure using force sensor measurements and controlled platform inclinations. The device may operate within two coordinate systems: the lift platform coordinate system (X, Z) and the world coordinate system (X′, Z′), where the horizontal reference plane may be defined by the XY plane. The X-axis of the lift platform may not necessarily aligned with any of the vehicle axes, ensuring general applicability across different system architectures. In some examples, the vehicle and the device may operate within the same reference coordinate system. The load 321 may have a COG depicted as 525.

In an example, the carrier structure 301 may include an adjustable (i.e. movable) surface that can be tilted at various angles (θ) relative to the horizontal plane. The device may control the tilting mechanism of the carrier structure 301, and the processor (e.g. the processor 401) may calculate the COG height H, as variations in inclination enable comparative force measurements that establish the vertical load distribution. The carrier structure's ability to modify tilt angles may be achieved via actuation systems, such as electric motors, hydraulic actuators, or linear servo drives, capable of fine-grained control to minimize oscillations or unintended biasing effects. The inclination angle (i.e. actual tilt angle) of the carrier structure 301 may be determined using onboard sensors, including encoders, accelerometers, or gyroscopes, which may provide feedback on its angular position in real time to the processor.

In an example, the load 321 may represent an object whose COG position 525 is to be computed. The height of the COG 525 of the load 321 may be defined both in relation to the lift platform (H) and the world coordinate system (H′). The device may allow for determining these positional relations by evaluating force components using force sensors (e.g. the force sensors 311) distributed along the lift platform. The force measurements by the force sensors are depicted as f1, f2 (denoted as f₁ and f₂ (i.e. fᵢ, i being an index of a corresponding sensor) in the equations). The measurements may be directed to forces exerted by the load 321 based on its mass (m) and gravitational acceleration (g), where the resultant forces (f1, f2) may be detected by the force sensors located at specific distances (d1, d2; (denoted as d₁ and d₂ (i.e. dᵢ, i being index of the corresponding sensor) in the equations)) relative to the world coordinate reference (X′). Given known tilting conditions, multiple force readings may facilitate the derivation of the COG location along the X′ coordinate using mathematical models.

In an example, force sensors may be positioned at distinct locations on the carrier structure 301 to capture the distributed force exerted by the load 321. These sensors may include strain gauges, load cells, or pressure transducers, each capable of converting force magnitudes into electrical signals processed by an onboard computation module. The distances (d1, d2) between force sensors may be pre-determined or calibrated dynamically, providing reference points that enable accurate force distribution mapping. The processor may determine the COG height by using a formula that describes the relation between COG position and tilt angle to the world coordinates is described in equation (1).

$${x}^{′} = x cos θ - H sin θ \qquad ( 1 )$$

The measured forces (f1, f2) contribute to aspects including computing the x′ position of the COG using equation (2):

$${\sum }_{i} {d}_{i} {f}_{i} - {x}^{′} mg = 0 \qquad ( 2 )$$

With the use equation (2), the processor may ensure that the sum of force sensor measurements multiplied by their respective distances equals the total force distribution applied across the carrier structure 301. Rearranging the above equation to solve for x′, the processor may calculate the COG using the formula, denoting the index of corresponding sensor of N corresponding sensors, N being an integer:

$${x}^{′} = \frac{mg}{{\sum }_{i} {d}_{i} {f}_{i}} \qquad ( 3 )$$

This formulation may allow the processor to derive the COG position in a non-intrusive, computationally effective manner without physically repositioning the load 321 relative to the carrier structure 301.

In an example, the device may utilize at least two distinct tilt angles to derive the COG height (H). By introducing tilt angles (θ₁, θ₂), the processor may compute distinct COG projections (x′₁, x′₂) at respective tilt angles using equations (4):

$${x}_{1}^{′} = x cos {θ}_{1} - H sin {θ}_{1} \qquad ( 4 )$$

$${x}_{2}^{′} = x cos {θ}_{2} - H sin {θ}_{2}$$

$${x}_{1}^{′} = \frac{mg}{{\sum }_{i} {d}_{i} {f}_{{i}_{{θ}_{1}}}}$$

$${x}_{2}^{′} = \frac{mg}{{\sum }_{i} {d}_{i} {f}_{{i}_{{θ}_{2}}}}$$

These equations may describe the positional shifts induced by the different inclination angles. The angular variations (θ₁, θ₂) may be recorded using the aforementioned inclinometers, encoders, or other onboard systems. The tilting mechanism may be controlled so that each adjusted tilt configuration produces meaningful but distinguishable force differences that enhance the accuracy of the COG computation. The processor may solve the equation (4) to identify H.

To determine H, we subtract the two equations in (4) corresponding to two different tilt angles θ1 and θ2:

$$H = \frac{{x}_{1}^{′} ( cos {θ}_{1} - cos {θ}_{2} ) - {x}_{2}^{′} cos {θ}_{1}}{sin {θ}_{1} - sin {θ}_{2}}$$

In an example, the processor may calculate tilt angles using the combined readings from the vehicle and the carrier structure 301 itself. The recorded angles could either be actively measured via integrated sensors or estimated using predefined operational parameters tailored to common use cases. The system benefits from using force sensors not only for traditional weight approximation but also for advanced COG detection based on equation-driven methodologies.

In an example, by moving one actuator slightly more than the other, the device may induce controlled micro-adjustments in tilt, allowing the COG to be computed without requiring significant movements of the entire platform. This approach may be critical in environments where minimal disturbances must be ensured, such as precision robotic handling, automated warehouse logistics, or self-balancing vehicle stabilization systems. Unlike conventional COG determination strategies that rely on substantial motion, this micro-adjustment technique may enable real-time and incremental COG evaluation, optimizing system responsiveness and reducing potential measurement errors.

Alternative implementations of this system may involve additional force sensors placed at intermediate positions to enhance measurement resolution, reducing reliance on precise tilting adjustments. Variants could also integrate distributed force mapping techniques using pressure-sensitive surfaces, allowing a more granular approach where force vector fields are analyzed to infer complex mass distributions. Furthermore, implementations employing machine learning models can leverage historical force data to predict COG adjustments dynamically.

This device may exhibit applicability across multiple domains, including autonomous material transport systems, robotic forklifts, aerial vehicle balance optimization, and smart weighing platforms. In logistics, autonomous vehicles transporting variable loads can benefit from real-time COG analysis to ensure optimal load balancing, reducing the risk of tipping during transit. In vertically moving platforms such as elevators, dynamically adjusting lift mechanisms may ensure stable load handling by iteratively refining COG approximations. Accurate weight distribution analysis can further enhance AGV efficiency, reducing mechanical wear due to unbalanced weight shifts.

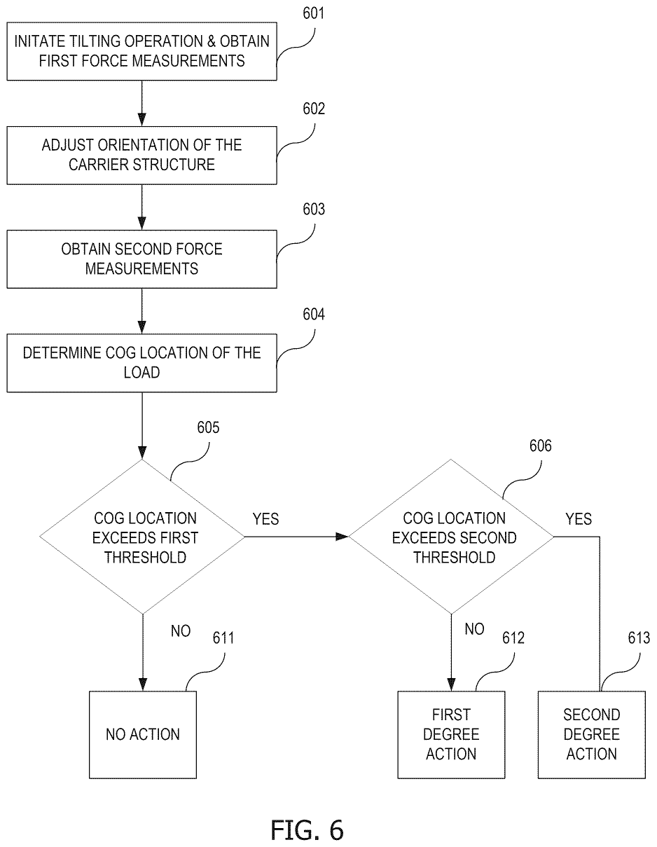

FIG. 6 shows an example of a flow diagram in accordance with aspects described herein. A processor (e.g. the processor 401) may implement aspects described herein for the flow diagram, unless indicated otherwise. The flow diagram may outline a sequence of operations for determination of a three-dimensional COG of a load on the vehicle and taking appropriate safety actions based on threshold evaluations. It is to be noted herein that the flow diagram has been illustrated to describe overall aspects and each portion of the operations described herein may be optional.

In 601, the processor 401 may instruct the vehicle to perform a tilting operation for determination of the COG location, which may be along z-axis (i.e. height) and preferably in x- and y-axes of the horizontal plane. In an example, the processor 401 may instruct the carrier structure controller to adjust the orientation of the carrier structure, such that the carrier structure has a first tilt angle relative to the horizontal plane. The carrier structure controller may cause the carrier structure to maintain the first tilt angle for a first period of time. In the first period of time, the vehicle may not move or initiate any further movement. At this stage, the processor 401 may collect first sensor data. For example, the first sensor data may include first force measurements of the force sensors 411, when the carrier structure is maintained at the first tilt angle. The processor 401 may determine the positions of the sensors 411. The processor 401 may further determine a first horizontal COG location along X and Y axes based on the positions of the sensors 411 and the first force measurements.

In 602, the processor 401 may initiate an adjustment of the carrier structure from the first tilt angle, in which the first force measurements are collected, to a second tilt angle that is different from the first tilt angle. The processor 401 may instruct the carrier structure controller to instruct the actuators configured to move the carrier structure to adjust the tilt angle. The carrier structure controller may cause the carrier structure to maintain the second tilt angle for a second period of time. In the second period of time, the vehicle may not move or initiate any further movement. At this stage, the processor 401 may collect second sensor data.

In 603, the processor 401 may instruct the force sensors 411 to perform second force measurements during the second period of time, when the carrier structure is maintained at the second tilt angle. The processor 401 may further determine a second horizontal COG location along X and Y axes based on the positions of the sensors 411 and the second force measurements.

In both 601 and 603, the processor 401 may instruct the memory 402 to store information representing force measurements (e.g. measured force values) received from the force sensors 411 as the first force measurements and the second force measurements respectively. Illustratively, the sensors 411 may measure forces exerted by the load along at least the Z-axis. These force measurements, transmitted to the processor 401 via the interface 403, may serve as the input for COG calculations. For example, the force sensors 411 may continuously send data (e.g. real-time data) representing the forces applied by the load on the carrier structure.

In both 601, and 603, the processor 401 may determine the first tilt angle and the second tilt angle and instruct the carrier structure controller by providing information representing the first and the second tilt angle. Furthermore, the processor 401 may receive further sensor data representing the orientation of the carrier structure relative to the vehicle's chassis. The processor 401 may monitor actual tilt angle of the carrier structure based on this received further sensor data. Illustratively, when the processor 401 determines that the actual (i.e. measured) tilt angle corresponds to the first tilt angle, the processor 401 may obtain the first force measurements in 601. Similarly, when the processor 401 determines that the actual tilt angle corresponds to the second tilt angle, the processor 401 may obtain the second force measurements in 603. For example, these further sensor data may be received from at least one of motor encoders, wheel encoders, or further sensors configured to measure tilt angles of the carrier structure.

In 604, the processor 401 may determine the COG location of the load at least along the Z-axis. The processor 401 may obtain stored COG location data along X and Y axes (e.g. stored during 601 and 603) as the first horizontal COG location and the second horizontal COG location. Additionally, or alternatively, the processor 401 may determine three dimensional COG location in 604 based on the force measurements, the sensor positions, and the tilt angles, illustratively as described herein. The processor 401 may calculate the COG location of the load along the Z-axis. The calculation may include solving equations derived from Newtonian mechanics to determine the vertical positions (horizontal locations) of the COG.

In 605, the processor 401 may evaluate if COG location exceeds first threshold. It is to be understood that this evaluation includes an evaluation along at least the Z-axis (e.g. COG-height). The thresholds described herein may include a distance or a location relative to a spatial point (e.g. ground, the plane defined by the carrier structure along X and Y axes, one of the force sensors, etc.), which is comparable with the COG location. Once the COG location is determined, the processor 401 may evaluate whether the COG location along at least Z-axis exceeds a predefined first threshold stored in the memory 402. This threshold may represent an acceptable limit for safe operation, beyond which corrective actions may be necessary. If the COG location does not exceed the first threshold, the processor 401 determines that no corrective actions are necessary in 611, and the vehicle may continue normal operation. For example, if the COG location exceeds the first threshold, the processor 401 may instruct the vehicle control system to reduce the vehicle's speed or adjust its braking distance to mitigate potential instability.

In one example, the processor 401 may further evaluate if the COG location exceeds a second threshold. For example, if the COG location exceeds the first threshold, the processor 401 may proceed to 606 in which the processor 401 may evaluate whether the COG location also exceeds a second, more critical, threshold. This threshold may represent a point at which the load is considered highly unstable, requiring immediate intervention. For example, if the second threshold is exceeded, the processor 401 may instruct the vehicle control system to halt movement entirely to prevent tipping or other safety hazards. The processor 401 may also generate an alert to notify the critical condition. If the COG location exceeds the first threshold but not the second, the processor 401 may implement a first degree action in 612 to maintain stability. This action may include reducing the vehicle's speed, adjusting its braking distance, or altering its acceleration profile. If the COG location exceeds the second threshold, the processor 401 may implement a second degree action, that is more restrictive of the movement of vehicle than the first degree action. This action may include halting the vehicle entirely, preventing further movement, and notifying of the unsafe condition.

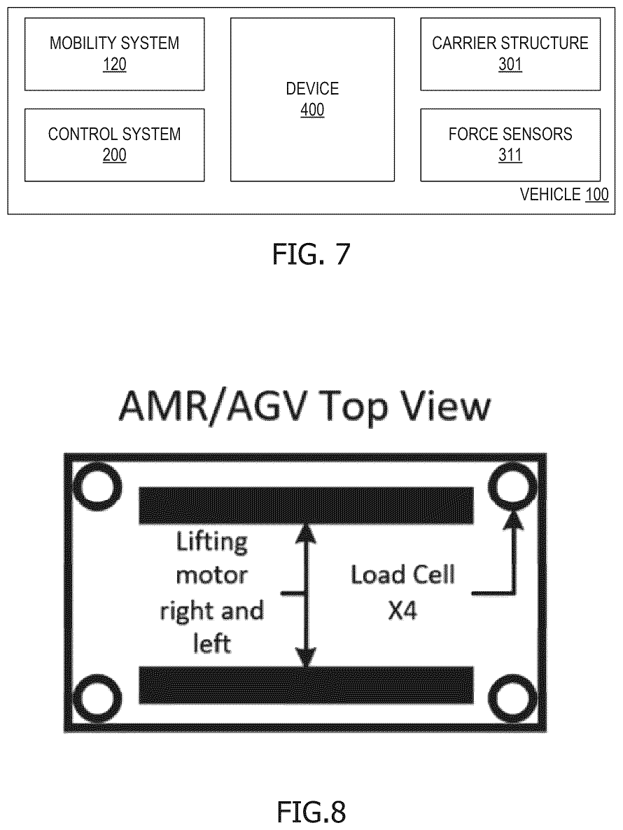

FIG. 7 shows an schematic illustration of a vehicle. Illustrative the vehicle corresponds to the vehicle 100 described herein. The vehicle 100 includes the mobility system 120, the control system 200, the device 400, the carrier structure 301, and the force sensors 311. In one example, the control system 200 may include the force sensors 311. Each force sensor 311 may correspond to a data acquisition device 112 or a measurement sensor 116 as described herein. In other words, the control system 200 may include the force sensors. Similarly, the control system 200 may further include the device 400. Illustratively, the processor 401 may be one or more processors 102 of the control system 200. In a further example, the mobility system 120 may include the carrier structure 301.

The vehicle 100 may dynamically monitor and determine the three-dimensional COG for loads during movement as described herein. Each component may contribute to the vehicle's ability to ensure operational safety and stability by calculating and responding to load-based dynamics. The mobility system 120 may facilitate the movement of the vehicle 100 and may include elements such as wheels, axles, propulsion mechanisms, and control components tailored to the vehicle's specific type (e.g., ground-based, aerial, or aquatic) as described herein.

The control system 200 may include the processing capabilities required to calculate and monitor the COG of loads. It may include the processor 401, which executes computations based on data collected from the force sensors 311. Additionally, the control system 200 may include integrated subsystems, such as a data acquisition interface and force transducers, enabling seamless communication with the mobility system 120 and the carrier structure 301 as described herein. The processor 401 may communicate with force sensors 311 via the interface 403 and use sensor data to determine force distributions caused by the load 321. By leveraging this information, the processor 401 may calculate the load's COG in three dimensions (X, Y, and Z axes).

The carrier structure 301 may serve as the load-bearing platform, to securely accommodate loads of varying sizes and shapes. The carrier structure 301 may be mechanically linked to the vehicle's chassis or housing and it may be configured to maintain the stability of the load 321 during movement. The force sensors 311 may be placed beneath the carrier structure 321 to measure forces exerted along the Z-axis and to monitor the load's distribution along the X and Y axes. The force sensors 311 may be load cells capable of detecting forces applied by the load 321. They may be positioned beneath the carrier structure 301 at specific locations to provide real-time data on load-induced forces. These sensors may enable the processor 401 to dynamically compute the COG and adapt the vehicle's operational parameters accordingly. They may be arranged at distinct positions along the X and Y axes to measure force distributions caused by the load 321.

The processor 401 may may issue commands to the mobility system 120 to adjust acceleration, velocity, or braking and to the control system 200 (or other components of the control system 200) to cause force measurements, receive information about force measurements, obtain information about sensor positions, etc. For instance, if the COG height (Z-axis value) exceeds a threshold, the control system 200 may limit the vehicle's velocity to ensure stability.

In an example, the processor 401 may continuously monitor the COG by calculating multiple COG values during the vehicle's operation. For example, the processor 401 may aggregate real-time data from the force sensors 311 to detect changes in the load's position or distribution. If the COG exceeds a predetermined safety threshold, the control system 200 may initiate corrective actions, such as adjusting velocity or alerting the operator. In the depicted vehicle 100, the processor 401 may execute safety operations if the COG exceeds specific thresholds. For instance: If the COG height (Z-axis) exceeds a first threshold, the system may reduce the vehicle's velocity. If the COG exceeds a second, more critical threshold, the system may prevent vehicle movement entirely to avoid tipping or instability.

The vehicle 100 illustrated may be adaptable for various applications, including autonomous mobile robots (AMRs) or automated guided vehicles (AGVs). In such cases, the control system 200 and mobility system 120 may operate without human intervention, relying on the processor 401 and force sensors 311 to ensure safe and efficient load transport.

In an example, as described herein, the carrier structure 301 may be tiltable by one or more actuators disposed at actuator positions relative to the carrier structure 301, with a carrier structure controller communicatively coupled to the one or more actuators to adjust the carrier structure 301 to at least two tilt angles relative to the horizontal plane. In an example, the control system 200 may include the carrier structure controller and the mobility system 120 may include the actuators. The carrier structure 301 may be mounted on a tilting mechanism, comprising actuators positioned strategically to facilitate controlled tilting. Actuators such as electric linear actuators, hydraulic pistons, or servo motors with gearboxes may be employed. The carrier structure controller, which may be integrated into the control system 200, may receive tilt angle commands from the processor 401, adjusting the actuators to achieve specified tilt angles. For example, the carrier structure 301 may tilt by +5 degrees and −5 degrees relative to the horizontal plane, enabling the processor 401 to calculate the vertical COG by analyzing force variations at these angles.

In an example, the one or more actuators may include a first actuator and a second actuator, with the carrier structure controller configured to control them to operate at different travel distances to create the at least two different tilt angles. The carrier structure 301 may include two actuators positioned along one axis, such as the Y-axis. The carrier structure controller may independently control each actuator, adjusting their travel distances to create corresponding tilt angles. For instance, the first actuator may extend by 10 mm while the second actuator extends by 5 mm, resulting in a tilt angle that facilitates accurate COG measurements. The actuators may include built-in position sensors, such as encoders or potentiometers, providing feedback to the processor 401 for tilt control and tilt angle measurements.

In an example, the processor 401 may further monitor the COG location over time by calculating a plurality of COG locations for the load and determining a safety operation if a COG location exceeds a predetermined threshold. The processor 401 may continuously receive force data from the sensors 311, calculating the COG at regular intervals. Historical COG data may be stored in the memory 402, allowing the processor 401 to detect trends or abrupt shifts in load distribution. If a calculated COG exceeds a predefined threshold, such as a height limit of 1.5 meters, the processor 401 may trigger safety operations, ensuring that the vehicle 100 remains stable during operation.

In an example, the processor 401 may instruct the control system 200 to limit maximum velocity, adjust minimum braking distance, or prevent vehicle movement. The processor 401 may dynamically adjust vehicle parameters based on COG calculations. For example, if the COG height exceeds a safe limit, the processor 401 may reduce the maximum velocity from 30 km/h to 20 km/h, increase braking distance by 20%, or halt vehicle movement entirely to prevent tipping. The control system 200 may execute these commands in real-time, ensuring safe operation under varying load conditions.

In an example, the vehicle may be an unmanned vehicle, an autonomous mobile robot, or an automated guided vehicle. The vehicle 100 may be implemented as an unmanned ground vehicle designed for logistics operations, an autonomous mobile robot for material handling in manufacturing environments, or an automated guided vehicle for warehouse operations. Each type of vehicle may leverage the described COG monitoring system to enhance stability, safety, and operational efficiency. The processor 401 may interface with navigation systems, ensuring that COG-based adjustments are seamlessly integrated into the vehicle's path planning and movement control algorithms.

FIG. 8 shows an illustrative example of a top view of a vehicle, which may be an automated mobile robot or automated guided vehicle, showing the placement of certain components including lifting motors and load cells. The rectangular outline may represent the carrier structure configured to carry loads during vehicle operation. At each corner of the carrier structure, a load cell is positioned, marked as “Load Cell X4,” to employ four load cells. These load cells may be arranged at known and predefined coordinates, allowing for accurate measurement of forces exerted by the load at each corner of the carrier structure.

The load cells may be force sensors and may include strain gauge-based load cells that measure the deformation caused by the load, converting it into electrical signals for processing by the processor. This placement can ensure that the load distribution is accurately captured, enabling the calculation of the COG in three dimensions. The placement of lifting motors on the right and left sides of the carrier structure are also shown. These lifting motors may serve as actuators to adjust the tilt angle of the carrier structure. By operating the lifting motors at different travel distances, the carrier structure can be tilted at desired angles, allowing the processor to measure force variations and calculate the vertical position of the COG. The lifting motors may include electric linear actuators with integrated position sensors, such as encoders, to provide feedback on their position and ensure accurate tilt control.

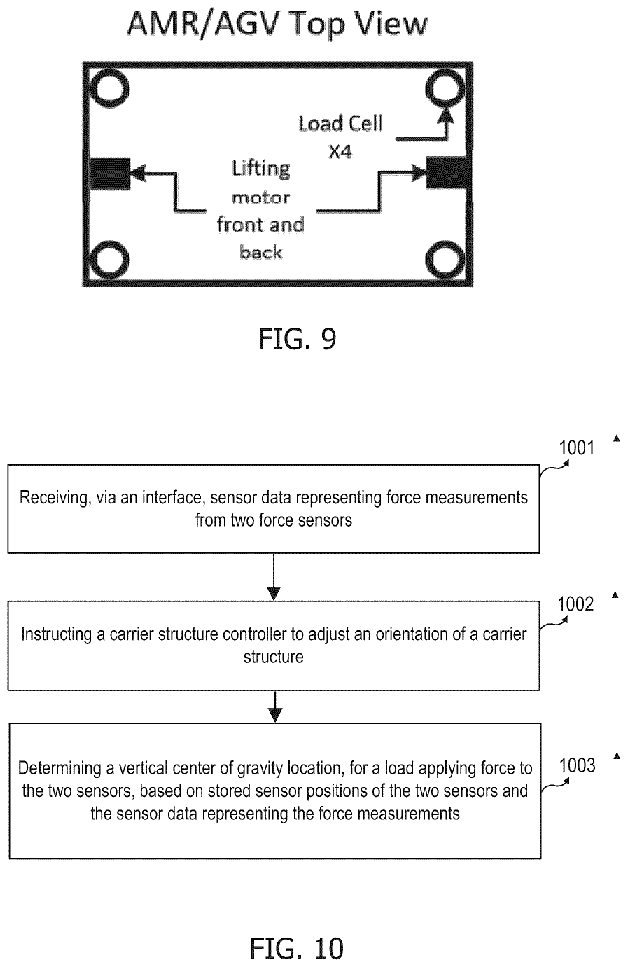

FIG. 9 shows an illustrative example of a top view of a vehicle, showing an alternative arrangement of the load cells and lifting motors compared to FIG. 8. The rectangular outline represents the carrier structure, which may be configured to carry loads during vehicle operation. Similar to FIG. 8, four load cells, labeled as “Load Cell X4,” are positioned at each corner of the carrier structure, to ensure accurate measurement of forces exerted by the load at predefined coordinates. These load cells may include load cells such as strain gauge-based load cells, capacitive sensors, or piezoelectric sensors, all capable of converting mechanical forces into electrical signals for precise force measurement and COG calculation.

In this arrangement, the lifting motors can be positioned at the front and back sides of the carrier structure, as indicated by the label “Lifting motor front and back.” These lifting motors may serve as actuators that control the tilt of the carrier structure along the longitudinal axis. The actuators may include electric linear actuators with integrated position feedback mechanisms, such as encoders or potentiometers, to allow precise control over the tilt angle. This arrangement can enable the carrier structure to tilt forward and backward, providing an additional degree of freedom for measuring load distribution and calculating the vertical position of the COG.

By tilting the carrier structure along the front-back axis, the processor can collect force data from the load cells at different angles, to ensure comprehensive analysis of load distribution. This configuration can enhance the vehicle's ability to dynamically monitor and adjust to load-based dynamics, ensuring operational safety, stability, and efficiency, particularly in automated logistics, material handling, and manufacturing environments.

FIG. 10 shows an example of a method. The method may include: receiving 1001 sensor data representing force measurements from at least two force sensors; instructing 1002 a carrier structure controller to adjust an orientation of a carrier structure, and determining 1003 a vertical COG location for a load applying force to the at least two sensors based on sensor positions of the at least two sensors and the sensor data representing the force measurements. A non-transitory computer readable medium may include instructions which, if executed by a processor, cause the processor to perform the method.

The following examples pertain to further aspects of this disclosure.

Example 1 may include the subject matter of a device including: an interface configured to receive sensor data representing force measurements from at least two force sensors; a processor configured to: instruct a carrier structure controller to adjust an orientation of a carrier structure; determine a vertical COG location for a load applying force to the at least two force sensors based on sensor positions of the at least two force sensors and the sensor data representing the force measurements.

Example 2 may include the subject matter of example 1, wherein the processor is further configured to: receive first sensor data representing first force measurements at a first tilt angle; instruct the carrier structure controller to adjust the carrier structure from the first tilt angle to a second tilt angle; receive second sensor data representing second force measurements at the second tilt angle; and determine the vertical COG location based on the first force measurements and the second force measurements.

Example 3 may include the subject matter of example 2, wherein the processor is further configured to instruct the carrier structure controller to adjust the carrier structure to the first tilt angle different from the second tilt angle before receiving the first sensor data.

Example 4 may include the subject matter of example 3, wherein the processor is further configured to determine the first tilt angle based on first tilt angle measurements after the carrier structure has been adjusted to the first tilt angle; wherein the processor is further configured to determine the second tilt angle based on second angle measurements after the carrier structure has been adjusted to the second tilt angle.

Example 5 may include the subject matter of example 2, wherein the first tilt angle and the second tilt angle are predetermined; wherein the processor is further configured to encode information representing the first tilt angle and the second tilt angle for a transmission to the carrier structure controller.

Example 6 may include the subject matter of any one of examples 2 to 5, wherein the vertical center of gravity location is along a first axis; wherein a horizontal plane includes a second axis and a third axis, wherein the second axis and the third axis are perpendicular to the first axis.

Example 7 may include the subject matter of example 6, wherein the processor is further configured to determine a horizontal COG location along at least one of the second axis and the third axis based on the sensor positions and the sensor data.

Example 8 may include the subject matter of any one of examples 6 or 7, wherein the processor is further configured to determine the vertical COG location and the horizontal COG location based on the sensor positions relative to a predefined point of origin.

Example 9 may include the subject matter of any one of examples 5 to 8, wherein the processor is further configured to: determine a first horizontal COG location along the at least one of the second axis and the third axis at the first tilt angle; determine a second horizontal COG location along the at least one of the second axis and the third axis at the second tilt angle; and determine the COG location along the first axis based on the first horizontal COG location and the second horizontal COG location.

Example 10 may include the subject matter of example 9, wherein the first horizontal COG location is determined based on the first force measurements; wherein the second horizontal COG location is determined based on the second force measurements.

Example 11 may include the subject matter of example 9 or example 10, wherein the processor is further configured to determine the vertical COG location by calculating the first horizontal COG location at the first tilt angle, the second horizontal COG location at the second tilt angle using a set of equations.

Example 12 may include the subject matter of any one of examples 1 to 11, wherein the at least two tilt angles are determined based on information received from at least one of motor encoders, wheel encoders, or further sensors configured to measure tilt angles of the carrier structure.

Example 13 may include the subject matter of any one of examples 1 to 12, wherein the processor is further configured to determine a result representing whether the vertical COG location along the axis satisfies one or more safety thresholds; and instruct the vehicle control system to perform a safety action based on the result.

Example 14 may include the subject matter of example 13, wherein the processor is further configured to perform at least one of the following: limit a velocity of the vehicle; adjust a braking distance of the vehicle if the COG location exceeds a first threshold of the one or more safety thresholds; or prevent movement of the vehicle if the COG location exceeds a second threshold of the one or more safety thresholds.

Example 15 may include the subject matter of any one of examples 1 to 14, wherein the at least two force sensors are configured to perform the force measurements along the axis; wherein the processor is further configured to determine the sensor positions along a horizontal plane; and wherein the vertical center of gravity location comprises an axis perpendicular to the horizontal plane.

Example 16 may include the subject matter includes a vehicle including: the device of any one of examples 1 to 15; the carrier structure configured to carry the load; and the at least two force sensors coupled to the interface.

Example 17 may include the subject matter of example 16, wherein the at least two force sensors are disposed beneath the carrier structure along the first axis at distinct locations along at least the second axis.

Example 18 may include the subject matter of any one of examples 16 to 17, wherein the at least two force sensors include load cells.

Example 19 may include the subject matter of any one of examples 16 to 18, wherein the carrier structure is tiltable by one or more actuators disposed at actuator positions relative to the carrier structure; wherein the vehicle further includes the carrier structure controller communicatively coupled to the one or more actuators to adjust the carrier structure to at least two tilt angles relative to the horizontal plane.

Example 20 may include the subject matter of example 19, wherein the one or more actuators include a first actuator and a second actuator; wherein the carrier structure controller is configured to control the first actuator and the second actuator to operate at different travel distances to create the at least two different tilt angles.

Example 21 may include the subject matter of any one of examples 16 to 20, wherein the processor is further configured to monitor the vertical COG location at the axis over time by calculating a plurality of vertical COG locations for the load and to determine a safety operation if a calculated vertical COG location exceeds a predetermined threshold.

Example 22 may include the subject matter of any one of examples 16 to 21, wherein the processor is further configured to instruct a vehicle control system to at least one of: limit maximum velocity of the vehicle; adjust minimum braking distance of the vehicle; or prevent the movement of the vehicle.

Example 23 may include the subject matter of any one of examples 16 to 22, wherein the vehicle is one of an unmanned vehicle; an autonomous mobile robot, or an automated guided vehicle.

Example 24 may include the subject matter of a method including: receiving sensor data representing force measurements from at least two force sensors; instructing a carrier structure controller to adjust an orientation of a carrier structure; and determining a vertical COG location, for a load that applies force to the at least two sensors, based on sensor positions of the at least two sensors and the sensor data representing the force measurements.

Example 25 may include the subject matter of example 24, further including: receiving first sensor data representing first force measurements at a first tilt angle; instructing the carrier structure controller to adjust the carrier structure from the first tilt angle to a second tilt angle; receiving second sensor data representing second force measurements at the second tilt angle; and determining the vertical COG location based on the first force measurements and the second force measurements.

Example 26 may include the subject matter of example 25, further including: instructing the carrier structure controller to adjust the carrier structure to the first tilt angle different from the second tilt angle before receiving the first sensor data.

Example 27 may include the subject matter of example 26, further including: determining the first tilt angle based on first tilt angle measurements after the carrier structure has been adjusted to the first tilt angle; determining the second tilt angle based on second angle measurements after the carrier structure has been adjusted to the second tilt angle.

Example 28 may include the subject matter of example 26, wherein the first tilt angle and the second tilt angle are predetermined, and the method further including: encoding information representing the first tilt angle and the second tilt angle for a transmission to the carrier structure controller.

Example 29 may include the subject matter of any one of examples 25 to 28, wherein the vertical COG location is along a first axis, and a horizontal plane includes a second axis and a third axis, the second axis or the third axis being perpendicular to the first axis.

Example 30 may include the subject matter of example 29, further including: determining a horizontal COG location along at least one of the second axis and the third axis based on the sensor positions and the sensor data.

Example 31 may include the subject matter of any one of examples 29 or 30, further including: determining the vertical COG location and the horizontal COG location based on the sensor positions relative to a predefined point of origin.

Example 32 may include the subject matter of any one of examples 28 to 31, further including: determining a first horizontal COG location along the at least one of the second axis and the third axis at the first tilt angle; determining a second horizontal COG location along the at least one of the second axis and the third axis at the second tilt angle; and determining the COG location along the first axis based on the first horizontal COG location and the second horizontal COG location.

Example 33 may include the subject matter of example 32, wherein: the first horizontal COG location is determined based on the first force measurements; and the second horizontal COG location is determined based on the second force measurements.

Example 34 may include the subject matter of any one of examples 32 or 33, further including: determining the vertical COG location by calculating the first horizontal COG location at the first tilt angle and the second horizontal COG location at the second tilt angle using a set of equations.

Example 35 may include the subject matter of any one of examples 24 to 34, wherein, the orientation is determined based on information received from at least one of motor encoders, wheel encoders, or further sensors configured to measure tilt angles of the carrier structure.

Example 36 may include the subject matter of any one of examples 24 to 35, further including: determining a result representing whether the vertical COG location along the axis satisfies one or more safety thresholds; and instructing a vehicle control system to perform a safety action based on the result.

Example 37 may include the subject matter of example 36, further including performing at least one of: limiting a velocity of the vehicle; adjusting a braking distance of the vehicle if the COG location exceeds a first threshold of the one or more safety thresholds; or preventing movement of the vehicle if the COG location exceeds a second threshold of the one or more safety thresholds.

Example 38 may include the subject matter of any one of examples 24 to 37, wherein the at least two force sensors perform the force measurements along the axis; wherein the processor is further configured to determine the sensor positions along a horizontal plane; and wherein the vertical center of gravity location comprises an axis perpendicular to the horizontal plane.

Example 39 may include the subject matter of any one of examples 24 to 38, wherein a vehicle includes the carrier structure configured to carry the load and the at least two force sensors coupled to the interface.

Example 40 may include the subject matter of example 39, further including: disposing the at least two force sensors beneath the carrier structure along the first axis at distinct locations along at least the second axis.

Example 41 may include the subject matter of any one of examples 39 to 40, further including: using load cells as the at least two force sensors.

Example 42 may include the subject matter of any one of examples 39 to 41, including: tilting the carrier structure by one or more actuators disposed at actuator positions relative to the carrier structure, and communicatively coupling a carrier structure controller to the one or more actuators to adjust the carrier structure to at least two tilt angles relative to the horizontal plane.

Example 43 may include the subject matter of example 42, further including: controlling a first actuator and a second actuator to operate at different travel distances to create the at least two different tilt angles.

Example 44 may include the subject matter of any one of examples 39 to 43, further including: monitoring the COG location at the axis over time by calculating a plurality of vertical COG locations for the load and determining a safety operation if a calculated vertical COG location exceeds a predetermined threshold.

Example 45 may include the subject matter of any one of examples 39 to 44, further including: instructing a vehicle control system to at least one of: limit maximum velocity of the vehicle; adjust minimum braking distance of the vehicle; or prevent the movement of the vehicle.

Example 46 may include the subject matter of any one of examples 39 to 45, wherein the vehicle is one of an unmanned vehicle, an autonomous mobile robot, or an automated guided vehicle.

Example 47 may include the subject matter includes a non-transitory computer-readable medium including instructions which, if executed by a processor, cause the processor to: receive sensor data representing force measurements from at least two force sensors; instruct a carrier structure controller to adjust an orientation of a carrier structure; determine a vertical COG location, for a load applying force to the at least two sensors, based on sensor positions of the at least two sensors and the sensor data representing the force measurements.

Example 48 may include the subject matter of example 47, wherein the instructions further cause the processor to: receive first sensor data representing first force measurements at a first tilt angle; instruct the carrier structure controller to adjust the carrier structure from the first tilt angle to a second tilt angle; receive second sensor data representing second force measurements at the second tilt angle; and determine the vertical COG location based on the first force measurements and the second force measurements.

Example 49 may include the subject matter of example 48, wherein the instructions further cause the processor to: instruct the carrier structure controller to adjust the carrier structure to the first tilt angle different from the second tilt angle before receiving the first sensor data.

Example 50 may include the subject matter of example 49, wherein the instructions further cause the processor to: determine the first tilt angle based on first tilt angle measurements after the carrier structure has been adjusted to the first tilt angle; determine the second tilt angle based on second angle measurements after the carrier structure has been adjusted to the second tilt angle.

Example 51 may include the subject matter of example 49, wherein the first tilt angle and the second tilt angle are predetermined, wherein the instructions further cause the processor to: encode information representing the first tilt angle and the second tilt angle for a transmission to the carrier structure controller.

Example 52 may include the subject matter of any one of examples 48 to 51, wherein the vertical COG location is along a first axis, and a horizontal plane includes a second axis and a third axis, the second axis and the third axis being perpendicular to the first axis.

Example 53 may include the subject matter of example 52, wherein the instructions further cause the processor to: determine a horizontal COG location along at least one of the second axis and the third axis based on the sensor positions and the sensor data.

Example 54 may include the subject matter of any one of examples 52 or 53, wherein the instructions further cause the processor to: determine the vertical COG location and the horizontal COG location based on the sensor positions relative to a predefined point of origin.

Example 55 may include the subject matter of any one of examples 51 to 54, wherein the instructions further cause the processor to: determine a first horizontal COG location along the at least one of the second axis and the third axis at the first tilt angle; determine a second horizontal COG location along the at least one of the second axis and the third axis at the second tilt angle; and determine the vertical COG location based on the first horizontal COG location and the second horizontal COG location.

Example 56 may include the subject matter of example 55, wherein: the first horizontal COG location is determined based on the first force measurements; and the second horizontal COG location is determined based on the second force measurements.

Example 57 may include the subject matter of any one of examples 55 or 56, wherein the instructions further cause the processor to: determine the vertical COG location by calculating the first horizontal COG location at the first tilt angle, the second horizontal COG location at the second tilt angle using a set of equations.

Example 58 may include the subject matter of any one of examples 47 to 57, wherein the orientation is determined based on information received from at least one of motor encoders, wheel encoders, or further sensors configured to measure tilt angles of the carrier structure.

Example 59 may include the subject matter of any one of examples 47 to 58, wherein the instructions further cause the processor to: determine a result representing whether the vertical COG location along the axis satisfies one or more safety thresholds; and instruct a vehicle control system to perform a safety action based on the result.

Example 60 may include the subject matter of example 59, including instructions which, if executed by a processor, cause the processor to perform at least one of: limiting a velocity of the vehicle; adjusting a braking distance of the vehicle if the COG location exceeds a first threshold of the one or more safety thresholds; or preventing movement of the vehicle if the COG location exceeds a second threshold of the one or more safety thresholds.

Example 61 may include the subject matter of any one of examples 47 to 60, wherein: the at least two force sensors perform the force measurements along the axis; wherein the sensor positions are determined along a horizontal plane; wherein the vertical center of gravity location comprises an axis perpendicular to the horizontal plane.

Example 62 may include the subject matter of any one of examples 47 to 61, wherein the instructions further cause the processor to control the carrier structure configured to carry the load and the at least two force sensors coupled to the interface.

Example 63 may include the subject matter of example 62, wherein the at least two force sensors are disposed beneath the carrier structure along the first axis at distinct locations along at least the second axis.

Example 64 may include the subject matter of any one of examples 62 to 63, wherein the at least two force sensors include load cells.

Example 65 may include the subject matter of any one of examples 62 to 64, wherein the instructions further cause the processor to: tilt the carrier structure by one or more actuators disposed at actuator positions relative to the carrier structure, and communicatively couple a carrier structure controller to the one or more actuators to adjust the carrier structure to at least two tilt angles relative to the horizontal plane.

Example 66 may include the subject matter of example 65, wherein the instructions further cause the processor to: control a first actuator and a second actuator to operate at different travel distances to create the at least two different tilt angles.

Example 67 may include the subject matter of any one of examples 62 to 66, wherein the instructions further cause the processor to: monitor the vertical COG location over time by calculating a plurality of vertical COG locations for the load and determining a safety operation if a calculated vertical COG location exceeds a predetermined threshold.

Example 68 may include the subject matter of any one of examples 62 to 67, wherein the instructions further cause the processor to: instruct a vehicle control system to at least one of: limit maximum velocity of the vehicle; adjust minimum braking distance of the vehicle; or prevent the movement of the vehicle.

Example 69 may include the subject matter of any one of examples 62 to 68, wherein the vehicle is one of an unmanned vehicle, an autonomous mobile robot, or an automated guided vehicle.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

All acronyms defined in the above description additionally hold in all claims included herein.

1. A device comprising:
an interface configured to receive sensor data representing force measurements from two force sensors;
a processor configured to:
instruct a carrier structure controller to adjust an orientation of a carrier structure; and
determine a vertical center of gravity location, for a load applying force to the two force sensors, based on stored sensor positions of the two force sensors and the sensor data representing the force measurements.

2. The device of claim 1,
wherein the processor is further configured to:
receive first sensor data representing first force measurements at a first tilt angle;
instruct the carrier structure controller to adjust the carrier structure from the first tilt angle to a second tilt angle;
receive second sensor data representing second force measurements at the second tilt angle; and
determine the vertical center of gravity location based on the first force measurements and the second force measurements.

3. The device of claim 2,
wherein the processor is further configured to instruct the carrier structure controller to adjust the carrier structure to the first tilt angle different from the second tilt angle before receiving the first sensor data.

4. The device of claim 3,
wherein the processor is further configured to determine the first tilt angle based on first tilt angle measurements after the carrier structure has been adjusted to the first tilt angle; and
wherein the processor is further configured to determine the second tilt angle based on second angle measurements after the carrier structure has been adjusted to the second tilt angle.

5. The device of claim 2,
wherein the first tilt angle and the second tilt angle are predetermined; and
wherein the processor is further configured to encode information representing the first tilt angle and the second tilt angle for a transmission to the carrier structure controller.

6. The device of claim 2,
wherein the vertical center of gravity location is along a first axis;
wherein a horizontal plane comprises a second axis and a third axis, wherein the second axis and the third axis are perpendicular to the first axis; and
wherein the processor is further configured to determine a horizontal center of gravity location along at least one of the second axis or the third axis based on the sensor positions and the sensor data.

7. The device of claim 6, wherein the processor is further configured to:
determine a first horizontal center of gravity location along the at least one of the second axis or the third axis at the first tilt angle;
determine a second horizontal center of gravity location along the at least one of the second axis or the third axis at the second tilt angle; and
determine the vertical center of gravity location based on the first horizontal center of gravity location and the second horizontal center of gravity location.

8. The device of claim 7,
wherein the first horizontal center of gravity location is determined based on the first force measurements; and
wherein the second horizontal center of gravity location is determined based on the second force measurements.

9. The device of claim 1,
wherein the orientation is determined based on information received from at least one of motor encoders, wheel encoders, or further sensors configured to measure tilt angles of the carrier structure.

10. The device of claim 1,
wherein the processor is further configured to determine a result representing whether the vertical center of gravity location satisfies one or more safety thresholds; and instruct a vehicle control system to perform a safety action based on the result.

11. The device of claim 1,
wherein the processor is further configured to determine the sensor positions along a horizontal plane;
wherein the vertical center of gravity location comprises an axis perpendicular to the horizontal plane; and
wherein the force measurements comprises force measurements along the axis.

12. A vehicle comprising:
a device comprising:
an interface configured to receive sensor data representing force measurements from two force sensors;
a processor configured to:
instruct a carrier structure controller to adjust an orientation of a carrier structure;
determine a vertical center of gravity location for a load applying force to the two sensors based on stored sensor positions of the two force sensors and the sensor data representing the force measurements;
the carrier structure configured to carry the load; and
the two force sensors coupled to the interface.

13. The vehicle of claim 12,
wherein the two force sensors are disposed beneath the carrier structure along a first axis at distinct locations along a second axis.

14. The vehicle of claim 12,
wherein the carrier structure is tiltable by one or more actuators disposed at actuator positions relative to the carrier structure; and
wherein the vehicle further comprises the carrier structure controller communicatively coupled to the one or more actuators to adjust the carrier structure to at least two tilt angles relative to a horizontal plane.

15. The vehicle of claim 14,
wherein the one or more actuators comprise a first actuator and a second actuator; and
wherein the carrier structure controller is configured to control the first actuator and the second actuator to operate at different travel distances to create the at least two tilt angles that are different from one another.

16. The vehicle of claim 14,
wherein the processor is further configured to monitor the vertical center of gravity location over time by calculating a plurality of center of gravity locations for the load and to determine a safety operation if the vertical center of gravity location exceeds a predetermined threshold.

17. The vehicle of claim 14,
wherein the processor is further configured to instruct a vehicle control system to at least one of: limit maximum velocity of the vehicle; adjust minimum braking distance of the vehicle; or prevent movement of the vehicle.

18. The vehicle of claim 14,
wherein the vehicle is one of an unmanned vehicle; an autonomous mobile robot, or an automated guided vehicle.

19. A non-transitory computer-readable medium comprising instructions which, if executed by a processor, cause the processor to:
receive sensor data representing force measurements from two force sensors;
instruct a carrier structure controller to adjust an orientation of a carrier structure;
determine a vertical center of gravity location, for a load applying force to the two sensors, based on stored sensor positions of the two force sensors and the sensor data representing the force measurements.

20. The non-transitory computer-readable medium of claim 19, wherein the instructions further cause the processor to:
receive first sensor data representing first force measurements at a first tilt angle;
instruct the carrier structure controller to adjust the carrier structure from the first tilt angle to a second tilt angle;
receive second sensor data representing second force measurements at the second tilt angle; and
determine the vertical center of gravity location based on the first force measurements and the second force measurements.
